(19) United States
(12) Patent Application Publication
(10) Pub. No.: US 2019/0337852 A1
(43) Pub. Date: Nov. 7, 2019

(54) REINFORCED UNFIRED BRICKS

(71) Applicant: Aubin Roque Fossouo Kenge, Detroit, MI (US)

(72) Inventor: Aubin Roque Fossouo Kenge, Detroit, MI (US)

(21) Appl. No.: 16/387,035

(22) Filed: Apr. 17, 2019

Related U.S. Application Data
(60) Provisional application No. 62/659,099, filed on Apr. 17, 2018.

(51) Int. Cl. C04B 28/00; C04B 18/24; C04B 24/08

(52) U.S. Cl. CPC C04B 28/001; C04B 24/085; C04B 18/248

(57) ABSTRACT

An unfired structural component such as a brick that is composed of soil components, cellulose fibers and at least one organic compound, the at least one organic compound selected from the group consisting of carboxylic acids and at least one aliphatic chain having between four and 28 carbon atoms in a matrix material composed of clay and soil particles .

### BACKGROUND

This application is a non-provisional application that claims the benefit of United States Provisional Application No. 62/659,099 filed Apr. 17, 2018, the specification of which is incorporated by reference herein in its entirety.

This disclosure relates to bricks suitable for use in construction. More particularly, this disclosure pertains to structural bricks that include fibrous material and suitable organic component(s).

There is a long-felt need to provide building materials for use in permanent structures and methods for producing the same that are cost effective and sustainable. In rural areas, particularly in countries with emerging or third world economies or regions, unfired clay bricks are the predominant method of construction. One of the drawbacks of such bricks is that they typically are very low strength units. In order to address this drawback, the unfired bricks are typically compounded or amended with various cellulose material. This addition is of limited value, particularly in regions experiencing high humidity or prolonged rainy seasons because such natural fibers are not durable in wet environments. Thus, it would be desirable to provide a brick structure and method for producing the same that exhibits elevated strength and resistance to wet environments. All too often mud bricks exhibit failures such as diagonal and vertical cracking, spalling, compressive failure excessive settlement and water infiltration that can lead to premature structural failure. It would also be desirable that the brick structure exhibit characteristics such as elevated strength and/or resistance to wet environments without requiring firing or other steps that necessitate the use of energy derived from fossil fuel.

Many people throughout the world cannot afford the current cost of building a decent and durable house. Approximately 50% of the population of developing countries, most rural people, and at least 20% of urban populations live in earth home. When building with bricks and bamboo, households will only spend money on roofing, finishing, furniture, door, and windows. Providing a brick improved brick material will permit may to own a decent and durable shelter. For many people this will be a significant step out of poverty, dependence, and marginalization.

Thus, the ability to provide unfired bricks having suitable durability and construction strength would benefit people in many regions of the world.

### SUMMARY

Disclosed herein is a brick that is composed of soil components, cellulose fibers and a at least one organic compound, the at least one organic compound selected from the group consisting of carboxylic acids and at least one aliphatic chain having between four and 28 carbon atoms. In certain embodiments, the at least one carboxylic acid will have at least one aliphatic chain having between two and five carbon-carbon double bonds. In certain embodiments, the cellulose fibers will include material derived from cellulosic materials such as grasses, bamboo, flax, hemp, ramie, cocoa fiber, and the like.

The process disclosed herein includes the steps of treating dried cellulosic materials such as grasses, bamboo, flax, hemp ramie and the like to an alkaline environment for an interval between 2 and 20 hours. The dried cellulosic fibers can have an average cross-sectional diameter sufficient to provide sufficient adhesion in the finished brick. In certain embodiments, the cross-sectional diameter of the various individual fibers can be less than 5 mm with diameters less than 1 mm in certain embodiments. The fibers can also have a suitable length. In certain embodiments, the fiber length can be less than 50 mm, with lengths of 15 to 35 mm being possible in certain embodiments.

Once the fibers have been treated with alkaline material, the fibers can be washed to neutralize the treated fibers and dried for an interval sufficient to remove latent water from the fiber material. The dried treated fibers are then mixed with particulate soil material and a suitable organic material composed of at least one carboxylic acid component. The resulting admixture is placed in a suitable brick or block frame and subjected to pressure up to 180 to 200 lbs. per square inch. Once a pressure maximum of 180 to 200 lbs. per square inch is reached, the brick is removed from the associated mold and allowed to air dry for an interval of at least 12 hours.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity:

FIG. 1 is as an SEM photomicrograph of untreated bamboo fibers;

FIG. 2 is an SEM of bamboo fibers treated according to an embodiment of the invention as disclosed herein;

FIG. 3 is a strain-stress diagram of untreated bamboo fiber;

FIG. 4 is a strain-stress diagram of bamboo fiber treated according to an embodiment of the invention as disclosed herein;

FIG. 5 is a graphical depiction of tensile stress values of fibers treated according to an embodiment of the invention as disclosed herein versus untreated fiber;

FIG. 6 is a graphical depiction of Young's modulus values of fibers treated according to an embodiment of the invention as disclosed herein versus untreated fiber;

FIG. 7 is a graphic depiction of the probability plot of selected treated fibers versus untreated fibers;

FIG. 8 is a non-limiting embodiment of a hydraulic jack machine and brick mold suitable for use in the present disclosure;

FIG. 9 is a graphic depiction of an embodiment of an embodiment of the compaction step of an embodiment of the invention as disclosed herein;

FIG. 10 is a depiction of representative bricks before and after crushing;

FIG. 11 is a graph of compression strength versus fiber content for bricks prepared according to an embodiment of the invention disclosed herein;

FIG. 13 is a stress-strain curve in the thickness direction for bricks prepared according to an embodiment of the invention as disclosed herein;

FIG. 14 is a stress-strain curve in the width direction for bricks prepared according to an embodiment of the invention as disclosed herein;

FIG. 15 is a stress-strain curve in the longitudinal direction for bricks prepared according to an embodiment of the invention as disclosed herein; and

FIG. 16 is a water absorption curve for untreated bricks and bricks according to an embodiment as disclosed herein.

### DETAILED DESCRIPTION

The present disclosure is predicated in the unexpected discover that treated cellulosic fibers when admixed with soil components in in the presence of an organic components such as a carboxylic acid having between two and five unsaturated bonds in a associated C4 to C28 alkyl group can provide brick or blocks with improved the physical and mechanical properties, thereby providing inexpensive and environmentally friendly construction material for developing countries.

Disclosed herein is a structural component such as a brick that has a central body. In certain embodiments, the central body has an upper face, a lower face opposed to the lower face as well as side walls and end walls contiguously joined to the upper and lower faces and defining a central core and can be can be configured as a rectangle or square. Other configurations are considered within the purview of this disclosure.

In the structural component as disclosed herein, the central core comprises a composite material. The composite material comprises soil composition particles, cellulose fibers and at least one organic compound. The at least one organic component included at least one carboxylic acid having an aliphatic chain having between four and 28 carbon atoms. In certain embodiments, the at least one organic component is molecule that includes at least one carboxylic acid group having an aliphatic chain having between four and 28 carbon atoms. In certain embodiments and the at least one organic component is molecule having at least one unsaturated carboxylic acid group having between two and five carbon-carbon double bonds.

In certain embodiments, the at least one organic compound in the composite material includes a triglyceride. The triglyceride can be one selected from the group consisting of alpha linoleic acid, linoleic acid and mixtures thereof. The triglyceride can further comprise at least one of the following: at least one saturated carboxylic acid having a C3 to C15 alkyl group, at least one monounsaturated carboxylic acid having a C3 to C15 alkyl group. In certain embodiments, the organic compound can be an oil containing oleic acid, linoleic acid and linolenic acid. Organic compounds suitable for use in the structural component as disclosed herein can be found in whole or in part in materials such as linseed oil, walnut oil, poppyseed oil, tung oil and mixtures thereof.

The at least one organic compound can be present in the structural component in an amount up to 10% w/w based on the total weight of the composite material. In certain embodiments, the at least one organic compound can be present in an amount between 0.5% and 9% w/w; between 0.5% and 8% w/w; between 0.5% and 7% w/w; between 0.5% and 6% w/w; between 0.5% and 5% w/w; between 0.5% and 4% w/w; between 0.5% and 3% w/w; between 0.5% and 2% w/w; between 0.5% and 1% w/w; between 1% and 9% w/w; between 1% and 8% w/w; between 1% and 7% w/w; between 1% and 6% w/w; between 1% and 5% w/w; between 1% and 4% w/w; between 1% and 3% w/w; between 0.5% and 10% w/w.

In the last decades, natural fibers have been increasingly used as reinforcement in composite materials. Due to its low cost, high specific strength, good mechanical properties and being a renewable resource, natural fiber such as bamboo fibers, hemp fibers, cocoa fibers, ramie fibers, grass fibers and the like have attracted the attention of scientists and engineers and is being considered as a substitute to synthetic fiber. However, natural fiber is not free from problems. Its high cellulose content and chemical structure allow moisture absorption. Thus, natural fiber is incompatible with many matrices. Additionally, the chemical difference between natural fiber and the matrix material is also a challenge to be overcome. The natural fibers also have limited thermal stability (usable temperature restricted up to 230° C.) and can be easily attacked in extreme environments.

It has been found, quite unexpectedly that certain natural fibers such as grasses, bamboo fibers, hemp fibers, cocoa fibers, ramie and the like provide economic and mechanical benefits that have been largely unappreciated, particularly when incorporated in unfired brick and block structures.

In various embodiments as disclosed herein, brick and/or block structures are disclosed that incorporate between with 0.5 to 10% w/w fiber content, with the fiber being derived from at least one of the following: grasses, bamboo, hemp, cocoa fiber, ramie, flax and the like. The fiber that is incorporated can be fiber that has been treated by contact with an alkaline material and dried to remove excess water from the treated fiber. The amount of fiber that is incorporated can be between 0.5 and 10% w/w in certain embodiments; in certain embodiments the fiber can be present in amounts between 0.5 and 9% w/w; between 0.5 and 8% w/w; between 0.5 and 7% w/w; between 0.5 and 6% w/w; between 0.5 and 5% w/w; between 0.5 and 4% w/w; between 0.5 and 3% w/w; between 0.5 and 2% w/w; between 0.5 and 1% w/w; between 3 and 8% w/w; between 3 and 7% w/w; between 3 and 6% w/w.

The fibers can have an average diameter less than 15 mm in certain embodiments. In some environments, the fibers can have an average diameter that is less than 10 mm; less than 5 mm; between 0.1 and 5 mm. The fibers employed can have an average length less than 80 mm in certain embodiments; while in other embodiments, the fibers will have an average length less than 50 mm; between 10 and 50 mm; between 10 and 40 mm; between 10 and 30 mm.

The composition as disclosed herein can include soil, soil and clay, between 0.5 and 10% w/w treated fiber and between 0.5 and 10% w/w of an organic liquid containing at least one suitable long chain unsaturated carboxylic acid having between four and 28 carbon atoms. In certain embodiments, the organic compound will be linseed oil.

The resulting brick or block will have a tensile strength as measure by INSTRON Universal Testing machine and following ASTM standards. Bending and the compressible test can be conducted on composite bricks using three-point load and compression machine respectively, following the requirement of ASTM. Scanning electron microscopic studies can be carried out to investigate the fiber surface morphology.

In certain embodiments, the fiber material employed is a derived from a bamboo material. Certain examples of material suitable for use include various types and species native to all continents except Antarctica and Europe. Bamboo can reach maturity in less than three years and can be harvested every two years for up to 120 years. It requires modest investment in planting to provide regular revenue. Bamboo fibers can be up to ten times stronger than wood fibers for construction. Bamboo is lighter and easy to carry than wood. Bamboo has highly contributed to the preservation of unstable soils and the protection of those degraded by massive deforestation. Its rapid growth, both aerial and subsurface and its willingness to occupy distributed areas make bamboo and an ideal resource for the conservation of unstable soils makes it highly desirable for use in certain developing regions of the world and makes it a sustainable material for many regions. In certain embodiments the cellulose fibers that are employed will have a moisture content less than 40%. In certain embodiments, the fibers employed will have a moisture content less than 30%; less than 20%, less than 10%; less than 5%; less than 3%; less than 2% less than 1%.

The matrix composition as disclosed herein includes a soil component and a clay component. Various soil and clay material have been employed in brick construction. Clay as that term is used herein is a fine-grained earthly material that becomes plastic when mixed with a certain amount of water. Clay derives from alteration either by weathering, hydrothermal action, deposited as sediment during an erosional cycle. As used herein the term “clay” is construed as material containing one or more compounds such as alumina (Al₂O₃) and silicates (SiO4), with small amount of potassium (K⁺), Sodium (Na⁺), Iron (Fe²⁺), Calcium (Ca²⁺) and Magnesium (Mg²⁺). Clay's main properties are plasticity, shrinkage, color, hardness, cohesion. Plasticity is a fundamental property of clay and defines the ability of the clay to deformed continuously under a force and to keep its shape when the force is removed. The plasticity of clays derives from the morphology of the clay mineral particles that slide over the others when mixed with water. Plasticity can be influence by the clay itself (composition, particle size distribution, water content, type of exchangeable cations, presence of organic material in the clay r by molding process (temperature, quality of water and pressure).

Three groups of clay mineral that are commonly found are kaolinite, illite and montmorillonite (i.e. Bentonite) with bentonite and kaolinite are the most common clay minerals used in building. Bentonite is a soft, plastic, light-colored rock composed primarily of clay mineral of the smectite group. Bentonite may also contain accessory crystal grains from the parent rock. Likewise, kaolinite is composed primarily of kaolite, nacrite, dickite. Kaolinite is commonly white, earthy and soft.

Various natural fibers are proposed for use in the bricks and brick-making process as disclosed herein. In certain embodiments, the fiber will be derived from bamboo or will exhibit attributes typically found in bamboo. The culms (trunk) are the most distinct part of bamboo plant species. The culm (cane) is the aerial stem and has distinctive nodes and hollow internodes. The properties of the culm are related to its anatomical structure. The bamboo culm is a cylindrical shell, which is divided by transversal diaphragms at the nodes. The culm has distinctive nodes and hollow internodes. The hollow space inside a culm is called cavity.

Bamboo is a collective name for different species of giant grasses. It is estimated that 60-90 genera of bamboo exist and approximately 1500 species. Some species can grow up to 150 feet, and this makes bamboo the tallest member of the grass family. Dendrocalamus giganteus is the world's largest grass with a height of 30-35 m. Individual bamboo culms can mature and be ready for cultivation in few years. Two non-limiting examples of bamboo suitable for use in the present disclosure include varous materials from the genus Guadaua. In certain embodiments, bamboo such as Phyllostachys pubescens, Guadua Angustifolia and Guadua anguisha can be used.

It has been found unexpectedly that among the natural fibers, bamboo fiber can be suitably used due to its various attractive properties. Bamboo fibers can be also serve as a substitute for natural plant fibers and provides many advantages, including low cost, low density, ecologically friendly, sustainability and biodegradability. The quality of bamboo's fiber not only depends on the fiber's extraction method and treatment but mostly on the quality and properties of bamboo itself.

Natural material such as bamboo suitable for use in the bricks or block disclosed will include cellulose, hemicellulose, and lignin, representing over 90% of the total mass. Natural materials of which bamboo is an example can also contain other chemical components in addition to cellulose and lignin such as 2-6% starch, 2% deoxidized saccharide, 2-4% fat, and 0.8-6% protein. Some of the characteristic values are fiber materials as used herein are variations in the cellulose content in the fiber, the variations in the degree of polymerization of the cellulose and the variations in the micro-fibrils angle of the fibers employed. Higher cellulose content, a higher degree of polymerization and a lower microfibrillar angle will affect higher tensile strength and modulus. The variations in the cellulose content value dictate the variations in mechanical properties both along the length of an individual fiber and between fibers.

The cellulose material can have the general formula

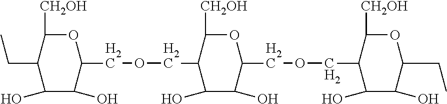

Cellulose, (C₆H₁₀O₅)ₙ is a Poly-saccharide made up of D-glucopyranose units linked together by b-(1-4)-glucosidic bonds. Without being bound to any theory, it is believed that the chemical structure of cellulosic fibers leads to properties such as mechanical resistance, biodegradability, and hydrophilicity. In the bamboo materials used herein, the bamboo derived material will be from the culm and can contain about 50% parenchyma, 40% fibers and 10% vessels and sieve tubes.

Cellulose constitutes the micro fibrils that make up the reinforced fibers in the matrix. In the natural fibers employed such as bamboo the cellulose fibers are aligned along the length of the bamboo which is believed to provide better mechanical properties in that direction. The presence of significant amount of hydroxyl group in cellulose gives natural fiber hydrophilic properties when used as reinforcement in a matrix; the result is an inferior interface and low resistance to moisture absorption. Without being bound to any theory, it is believed that the processing and treatment steps as disclosed herein address and overcome at least a portion of these drawbacks.

The hemicellulose component contains a variety of different types of monosaccharides that remain connected to the cellulose after lignin has been removed. Hemicellulose contains several different sugar units whereas cellulose contains only 1,4-b-d-glucopyranose units. Hemicellulose exhibit a considerable degree of chain branching, whereas cellulose is a strictly linear polymer. The level of polymerization of native cellulose is ten to one hundred times higher than that of hemicellulose. Hemicellulosic polymers are branched, fully amorphous and have a significantly lower molecular weight than cellulose and can form hydrogen bonds with cellulose which helps to bind up cellulose into the micro fibrils. Cellulose, hemicelluloses, and lignin make about 90% of total weight of bamboo fiber. Hemicelluloses are bound up with pectin to cellulose to form a network of cross-linked fibers in plants. The hemicellulose in bamboo has its principal component xylan between that of the hardwood and softwood.

The circular cross section is composed of cellulosic fibers oriented parallel to the culm's longitudinal axis embedded in a lignin matrix. The fibers, which provide the culm's strength, are grouped around vessels for water and sap transport in vascular bundles. The spaces between adjacent strands of fibers are filled with lignin, a thermoplastic resin. Bamboo has a percentage of lignin (32%) and a micro-fibrillar angle of (20-100). Lignin is hard to breakdown and therefore provides strength and rigidity to the cell walls. These factors lead to the extremely high tensile strength, flexural strength and rigidity of the fibers' poly-lamellate wall structure.

Ash is a term used to refer to inorganic substances such as silicates, sulfates, carbonates, or metal ions. The ash present in bamboo is made up of inorganic minerals, primarily silica, calcium, and potassium. Silica is higher in the epidermis, with tiny in the nodes and it is absent in the internodes.

In certain embodiments, the specific gravity of bamboo material employed herein will be between 0.4 and 0.8. The average density of bamboo can be about 648 kg/m3 (40.5 lb/ft³). It is posited that the strength of bamboo comes from the vascular bundles in the culm. An increase in strength occurs between 2.5 to 4 years. For bamboo to reach an optimum strength, there is a ‘maturity age.’ Thus, in certain embodiments, the resulting structures as disclosed herein will be composed of between 10 and 100% mature bamboo material that has been harvested after 25 years of age. Bamboo possesses a relatively high tensile strength. Some species can reach 370 Mpa which is higher than that of standard woods such as fir, pine, and spruce (˜30-50 Mpa), however heretofore it has been hard to construct connections that can transfer this tensile strength. Into surrounding structural members. Bamboo has been cited as having a tensile strength similar to mild steel in some cases. The compression strength of full-culm bamboo has been studied. As with bending strength, the ultimate compressive stress of air-dry bamboo is estimated as 0.094 times the density in kg/m³.

Green bamboo can have a moisture content of 100-150%, depending on factors including but not limited to the species, area of growth and season. At a young age, bamboo has a high relative moisture content of about 120-130%. The nodes show lower values than the internodes. Once harvested, the moisture content of bamboos can be influenced by factors such as the humidity and the environment. The shrinkage of bamboo starts immediately after the harvest. After the bamboo is cut, its water content decreases and dry shrinkage begins. This process is irregular, and is directionally variable in one of more of the radial, tangential and lengthwise direction. In many aplications dshrinkage and drying will and stop at levels of about 40% moisture content. For example, it has been reported that when the moisture loss of phyllostachys pubescens reaches 1%, the average shrinkage rate is: lengthwise 0.024%, tangential 0.1822%, radial 0.1890% .

In certain embodiments, it is beleived that bamboo may provide an advantage over other engineered materials. This has been investigated in terms of modulus of elasticity, E, and density q. Data is shown in the various drawing figures, where the line presenting the equation C=E^{1/2}/q applies to the properties of bamboo.

As used herein, the term “natural fiber” is a substance that has an elongated structure (diameter negligible in comparison to the length). The fibers can be made out of several fibrils that run all along the length of the fiber. The hydrogen bonds and other linkages provide the necessary strength and stiffness to the fibers. As used herein “natural fibers” are derived in whole or in part from plant materials and include cellulose.

A major concern when using natural fiber and natural fiber composite material is its ability to absorb water. Increased moisture content decreases the desired mechanical properties and provides the necessary condition for biodegradation and dimensional instability. Change of dimensions has the effect of breaking the bond strength between the clay brick matrix and the natural fiber in the resulting structural block. The presence of hydrophilic(—OH) groups in the fibers results in such higher absorption of water for natural fibers. The hydroxide group strongly reacts with water. This hydrophilic (water loving) nature leads to incompatibility and weak bonding in the fiber/matrix interface.

The effect of water absorption on the mechanical properties of hemp fibers reinforced unsaturated polyester composites was studied and compared the influence of both fiber reinforcement and water on mechanical properties of hemp fibers reinforcing unsaturated polyester composites. Hemp fibers were first dried at 100° C. to remove storage moisture in an oven. The sample was prepared by mixing fiber and matrix. Specimens containing 0, 0.10, 0.15, 0.21 and 0.26 fiber volume fractions were prepared. After being taken out from the hydraulic press, the respective panels were left to cure at a temperature of 22° C. for 24 hours before being removed from the mold. Subsequently, post curing was carried out at a temperature of 80° C. for three hours. Water absorption tests were conducted by soaking specimens in a water bath at 25° C. and 100° C. for 24 hours. After immersion for 24 hours, the specimens were taken out from the water and dry in the air. The tensile and flexural properties of water immersed specimens' conditions were evaluated and compared alongside dry composite specimens. The tensile strength and modulus of the hemp fibers reinforced composites before and after water immersion was found with a test machine crosshead load speed of 10 mm/min. The flexural strength and modulus of the composite before and after water immersion were determined using three-point bending test method. The effect of water absorption on the microstructure of composites was examined by using a scanning electron microscope (SEM) JSM 6100. It shows that moisture uptake increase with fibers volume fraction increases due to increased voids and cellulose content. It was concluded that exposure to moisture results in significant drops in tensile and flexural properties due to the degradation of the fibers-matrix interface.

In the process and structural component as disclosed herein, it has been found that alkaline materials such as caustics can be employed to treat fibers such as bamboo. Lye concentration (0.5, 1, 2, 4 and 10%) for treating sisal fiber-reinforced composites and concluded that maximum tensile strength resulted from the 4% alkaline treatment at room temperature has been studied. Stress-strain measurements were carried out at a crosshead speed of 500 mm per minute. The tensile strength was evaluated following the ASTM standards. Scanning electron microscopic studies were conducted to analyze the fracture behavior of the composites. The results also showed that at low levels of fiber loading, the orientation of fibers is poor and the fibers are not capable of transferring the load to one another, leading to low tensile strength. At high levels of fiber loading, the increased population of fibers leads to agglomeration and stress transfer gets blocked. At intermediate levels of loading (30 per hundred parts of polymer in mass), the population of the fibers is just right for maximum orientation and the fibers actively participate in stress transfer. The effect of fiber length and content on the mechanical properties of the fiber-reinforced composite have also been investigated.

An additional study investigated the effect of fiber surface treatment on the fiber-matrix bond strength of natural fiber reinforced composites. The fibers (henequen: Agave fourcroydes) were treated with a NaOH aqueous solution (2% weight/volume) for an hour at 25° C.; then they were washed with water until all the sodium hydroxide was neutralized, that is until the water used for washing the fibers no longer gave any alkalinity reaction. Subsequently, the fibers were dried at 60° C. for 24 hours. The henequén fibers were impregnated with a 1.5% (weight/weight) High-density polyethylene solution. The natural fibers were put in a basket and carefully immersed in the hot solution and stirred continuously for 5 min. Then, the basket was removed, and the lumps of fibers were transferred to a flat tray and kept in an oven at 60° C. for 24 hours to allow the solvent to evaporate. The interfacial shear strength was measured by using is the pull-out test. The interfacial shear strength between natural fibers and thermoplastic matrices was improved by morphological modification of the fiber surface. A 20% in volume fiber composite was elaborated to determine the effect of the henequén fiber surface treatments on the tensile properties of the material. Henequén fibers (6 mm long) were incorporated into the polyethylene matrix. The tensile tests were conducted in an INSTRON Universal Testing machine model 1125 using a cross-head speed of 5 mm/min. The results showed that the treatment of the henequén fibers with a alkaline solution promotes the partial removal of the hemicelluloses, waxes, and lignin present on the surface of the fiber, and leads to some changes (more crevices) in their morphology (morphology of the treated fiber was studied by scanning electron microscopy (SEM) and chemical composition. It has been noted that there is a stronger absorption of water in untreated fiber than the treated one. No significant difference in tensile strength was observed between treated-fiber composite and the untreated fiber composite. Previous research also supported the conclusion that, when treated, natural fiber, can be used in composite material and can contribute to improving its properties. Similar results were reported by Layth Mohammed et al. when they studied the effects of various chemical treatments on the mechanical and thermal properties of natural fibers reinforcements thermosetting and thermoplastics composites.

Jute and sisal fibers are treated with 5% aqueous NaOH solution for two up to 72 h at room temperature. Similar treatments were attempted by Morrison et al. to treat flax fiber. Garcia et al. reported that 2% alkali solution for 90 s at 200 C and 1.5 Mpa pressure was suitable for degumming and defibrillation to individual fibers. These researchers observed that alkali led to an increase in amorphous cellulose content at the expense of crystalline cellulose. The maximum tensile strength is obtained from the 4% NaOH treatment at room temperature. It was also reported that at higher alkali concentration, excess delignification of natural fiber occurs resulting in a weaker or damaged fiber. Additionally, bamboo's fiber treatments have been explored using Silane (SiH4), acetylation (describes a reaction introducing an acetyl functional group (CH₃COO—) into an organic compound), benzoylation (Benzoyl chloride includes benzoyl (C₆H₅C=O) which is attributed to the decreased hydrophilic nature of the treated fiber and improved interaction with the composite.

The term bamboo as applied herein referes to a natural composite material, with dense fiber in the outer surface region. Bamboo fibers are increasingly becoming attractive and present some advantages over others natural fibers and glass fibers in composite applications. The environmental sustainability, mechanical properties and recyclability of bamboo have promoted its use in reinforcing polymer composite. Bamboo can also be utilized for a variety of structural and semi-structural applications due to its excellent specific properties, renewability and other environmental benefits, which include a significant CO₂ capture and low energy consumption per kg of fibers. Plant fiber like bamboo consists of four main parts: cellulose, hemicellulose, lignin, and pectin. Cellulose fiber is distributed in a lignin matrix in the form of natural composite.

Although bamboo has fast growth compared to other sources of natural fiber, there has been little research on using its fiber as reinforcement in structural components. Various extraction methods have been employed to extract bamboo fiber. Non-limiting examples include retting, heat streaming, and rolling mill. The steam explosion method has been used to separate lignin from the plant surface; the resulting fibers were rigid and dark. The results indicated that steam exploded bamboo fibers have a higher tensile strength than silane treated fibers. On the other hand, the interfaces between the fibers and soft cells are weak, and these interfaces may reduce the tensile strength of the fiber reinforced thermoplastic. In the retting method, culm was peeled to obtain strips. The strips of bundles were kept for three days in water. Then, to separate the fibers, the wetted strips were beaten, scraped with a sharp-edged knife and combed. It has been found that every extracted fiber bundle consisted of a single fiber, and these fibers could be acquired in any length. In the rolling mill process, bamboo culm was cut from the nodes into smaller pieces, and these pieces were then cut into strips with a thickness of 1 mm. The strips can be soaked in water for one hour to facilitate the separation of fibers and then passed through the rolling mill at low speed and under slight pressure. The rolled strips can be soaked in water for at least 30 min and then separated into fibers with a razor blade. The obtained fibers, ranging in length from 220 to 270 mm, can then be dried in the sun for two weeks.

The overall conclusion are that 1. The steam explosion mechanical method and chemical methods can remove lignin from bamboo fibers, influencing the microstructure of bamboo. The fibers extracted using these procedures were short; 2. The retting and rolling mill methods produced long fiber; 3. Alkali treatment in the category of chemical extraction method could remove lignin from fibers and improve the interfacial adhesion of composite.

In certain embodiments bamboo fiber having ranging between 4 mm and 25 mm in length, and having a diameter greater than 0.2 mm has been extracted by steam explosion and alkali-treated in 0.25mol/L solution at room temperature for 30 minutes presenting a random fiber distribution in the matrix. The mixture with 50% (mass)fiber ban be pressed under a constant pressure of 20MPa for 5 minutes. The mixture can be dried in an oven at 105° C. for two hours.

Tensile and flexural tests carried out using INSTRON and a 3-point bending machine illustrate dependence on fiber length and content. The results show that when the fiber length was less than 15 mm, both tensile and flexural strength of fiber-reinforced green composite increase with increasing fiber length; the trend in increasing strength was saturated for fibers length over 15 mm. The basic mix design of the composites for both types of processing was 45% cement, 12% silica fume, 3% fibers and 1% superplasticizer (by volume), with 0.29 water/cement ratio (by weight). In both cases, 2 mm, 4 mm and 6 mm fiber lengths were used. Then the specimens were oven-dried at 105° C. for 24 hours. Tensile and flexural tests were conducted to evaluate the mechanical performance of the composites. An increase in the composite strength and toughness was observed for shorter fiber length (2 mm) in both tensile and flexural tests for extruded composite. This supports that fiber length can affect the strength of a resulting composite.

It is contemplated that various factors can affect the performance of natural fiber in in composite material. These can include on or more of: (a) orientation of fiber (b) strength of fibers, (c) physical properties of fibers, (d) interfacial adhesion property of fibers. It is contemplated that the aspect ratio of the fibers, and the fiber-matrix interface can govern the properties of the resutling composites. The surface adhesion between the fiber and the surrounding material can play a significant role in the transmission of stress from the matrix to the fiber and thus contributes toward the performance of the associated composite.

In the structural brick or block as disclosed herein, the associated brick or block can be reinforced with up to 10% w/w fiber content in certain embodiments. In certain embodiments, the fiber content can be up to 7% w/w; up to 5% w/w between 1 and 7% w/w.

Fiber length can be between 5 and 35 mm in certain embodiments. While in other embodiments, the length can be between 10 and 35 mm, between 10 and 25 mm, between 15 and 30 mm. The fiber material can be derived form at least one of grasses, bamboo, flax, hemp, ramie, cocoa fiber and the like, with bamboo being employed in certain applications.

As disclosed herein, bamboo fibers can be extracted from raw bamboo by one or more various techniques. Non-limiting examples of such extraction techniques in steam explosion, roller mill techniques, and compression machine extraction. These techniques differ by the fiber diameter and length produced. The procedure for extracting bamboo fiber can be grouped into three classes: mechanical, chemical and combined mechanical and chemical extraction. Mechanical extraction methods can be more eco-friendly than chemical methods in certain applications. Steam explosion and chemical methods can affect the microstructure of bamboo fibers. The mechanical extraction method can include steam explosion, retting, crushing, grinding and rolling in a mill. The steam extraction method separate cell walls of the plant to produce pulp. Under pressure and increased temperature, steam and additives penetrate the fiber interspaces of the fiber bundles. This extraction technique uses a vessel boil water into steam and thereby splitting the bamboo into fibers.

Although the steam explosion procedure is an appropriate method to separate lignin from the plant surface, the resulting fibers are rigid and dark. The primary function of this technique is to remove lignin from woody materials. During the steam explosion, the cell walls of the fibers are cracked, and bamboo fibers become soft, enabling extraction. Retting is a chemical process for removing non-cellulosic element attached to fibers to release individual fibers. In this process, the bamboo skin is removed, and the cylindrical part of the culm is peeled to obtain strips. The resulting fiber strips of the bundles can be maintained for an intervals up to for some days in water so to degrade the lignin. In order to separate the fibers, the wetted strips are beaten, scraped with a sharp-edged knife and combed. This method results in a robust and excellent fiber quality. The quality of renting determines the quality of fibers. In rolling milling bamboo culm is cut from the nodes into smaller pieces, and then these pieces are cut into strips with a thickness of about one millimeter. The strips are soaked in water for one hour to facilitate the separation of fibers after which the strips are passed through the rolling mill at low speed and under slight pressure. The rolled strips are soaked in water for about 30 minutes and then separated into fibers with a razor blade. The fibers are then dried for about two weeks.

When used in structural composites in order to prevent failures, the natural fiber as disclosed herein may be treated to address and mediate between the hydrophilic nature of fibers and the hydrophobic behavior of matrix. Physical and/or chemcial modification of fibers can be affested in order to make it less hydrophilic. Without being bound to any theory, it is believed that the behavior of the resulting composite depends not only on the properties of the individual materials but also and mainly on the quality of the interface between the two materials.

In the process and brick structural component as disclosed herein, it is desirable to keep as much water as possible from permeating into the fiber structure. Despite the previous research, water or moisture content is still of great concern. Physical treatments have included various techniques among which electric discharge (corona, plasma treatments) and UV are the most explored. Their effects are surface “cleaning”, changes in the chemical structure (functional groups, radicals and even crosslinking) to modification of the surface energy. The physical modification is one of the methods used to modify the surface properties of the natural fiber. It is the effective method to improve the fiber-matrix interaction in composites. Ultraviolet (UV) treatment is an example of physical modification. UV treatment impairs the polarity of the natural fibers. The modification of surface properties of fiber using plasma is also used. It is an innovative technique; this treatment aims to increase the mechanical grip on fiber-matrix interface by modifying the surface properties of fibers without significant changes in its molecular structure. The fiber surface roughness is expected to increase due to ions bombardment. Other physical methods, such as stretching, calandering are also used. They do not alter the chemical composition of the fibers but the structural and surface properties of the fiber and therefore influence the mechanical bonding to polymers. In certain embodiments, when two materials are incompatible, a third material can be incorporated that has properties intermediate between the two incompatible materials so to create compatibility.

In order to provide a brick structure component that can resist applied force in all directions, the process as disclosed herein includes a step in which fiber is mixed with a sufficient amount of clay to prevent fiber exposure. The resulting material is categorized as a Fibrous Composite-Short fiber. The resulting Fibrous composite short fiber as disclsoed hering is a matrix reinforced by phase in the form of discontinuous fibers randomly distributed within the matrix.

It was also believed that the aspect ratio of the fibers relative to the fiber-matrix interface in the structure governs the properties of the resulting composites. The surface adhesion between the fiber and the composite can play a major role in the transmission of stress from the matrix to the fiber and thus contributes toward the performance of the structural composite. In short-fiber-reinforced composites, there exists a fiber length that can develop its full stressed condition in the matrix. Fiber lengths shorter than the desired length can lead to increased failure. rates On the other hand, for fiber lengths greater than the desired length, the fiber can be stressed under an applied load and prodcuce results in a higher strength of the composite. This is mitigated by situations in which the increase fiber length over desired length compromise the toughness of the structural composite.

To make natural fibers a suitable reinforcing material, various modification methods, including alkali treatment, graft modification, and infiltration habe been proposed to improve interfacial compatibility. In certain applications, chemical treatments can increase the interface adhesion between the fiber and matrix and decrease the water absorption of fibers. Chemicals may also activate hydroxyl groups that can efficiently interlock with the matrix. Bonding between the reinforcing fiber and the matrix greatly impacts the properties of the resulting structural composite as this bond can be responsible for transferring some or all of the stress imparted to the matrix to the fiber reinforcement. The degree of adhesion between the components can determine the distribution and the transfer of the loads.

In the process as disclosed herein one or more of several chemical treatments may be used for the treatment of fiber material such as bamboo fiber. Non-limiting examples of such chemical treatments include sodium hydroxide (NaOH), silane (SiH4), acetic acid (CH₃OH), Benzoly Chloride (C₆H₅—CH₂CL), Maleic anhydride (C₄H₂O₃), potassium permanganate, peroxide. Modification of the fiber properties by using coupling agents can be employed. Suitable coupling agents for use in the process as disclosed herein are those that react with hydroxyl groups, exposing the cellulose structure to react with the matrix.

In certain embodiments, the fiber is subjected to the action of a concentrated aqueous solution of a strong base in a manner that produces swelling with resultant changes in fine structure, dimensions, morphology, and mechanical properties. It is believed that his process will increase interfacial adhesion by removing one or more of hemicellulose, lignin, and other components from natural fiber, resulting in a purified cellulose. Lignin can be dissolved in sodium hydroxide (NaOH) solution, and then the cellulosic fibers can be extracted.

Among the natural fibers, bamboo fiber can be suitably used due to its high strength properties and its availability at low cost. Chemical treatment using NaOH can be employed in the process as disclosed herein to improve the matrix-fiber interface and to achieve compatibility between the matrix and bamboo fiber reinforcement. In certain embodiments, the fiber will be treated with a solution containing between 2 and 8% NaOH for a suitable. In certain embodiments, the fiber will be treated with between 3 and 5% NaOH for a suitable interval. The treatment interval can be between 1 and 8 hours in certain embodiments with intervals between 3 and 5 hours employed in certain embodiments.

Without being bound to any theory, it is believed that substantial modification done by alkali treatment includes the disruption of hydrogen bonding in the network structure as depicted in the following equations resulting in increased surface roughness. The reaction of NaOH with natural fiber leads to the ionization of the hydroxyl group to the alkoxide according to the following equation:

Fiber-OH+NaOH→Fiber-O—Na+H₂O

It is believed that this treatment removes at least a portion of components includeing but not limited to lignin, wax, and oils covering the outer face of the fiber cell wall. It is also believed that this treatment depolymerizes cellulose and exposes the short length crystallites. It is also believed that the process produces micropores in the fiber and increases the fiber surface area. Thus, alkaline treatment influences the cellulosic fibril, the degree of polymerization and the extraction of lignin and hemicellulosic compounds and increases the stability of composites. In brief, the alkali treatment can have one or both of the following effects on the fiber: (1) increased surface roughness resulting in better mechanical interlocking; and (2) an enhanced amount of cellulose exposed on the fiber surface, thus increasing the number of avaailble reaction sites.

Without being bound to any theory, it is believed that the presence of an organic constituent that includes at least one carboxylic acid having a C4 to C28 alkyl groups that has two to five unsaturated bonds in the alkyl group contributes a non-polarity to the associated structure. In certain embodiments, the organic constituent can be linseed oil. It is theorized that the oil, as a non-polar molecule does not resist an external force at its surface. Since the forces of attraction between the molecules of a liquid decrease with the temperature, the surface tension decreases with increasing temperature. Therefore, the additional strength obtained with the substitution by the presence of the organic constituent outlined herein is believed to be the difference in tension surface. The presence of the organic compound contributes towards the creation of a stronger network of organic compound, clay and fiber, thus improving binding of the fiber with clay material.

In applications where the organic constituent is linseed oil, it is believed that the drying power of linseed oil is directly related to the chemical reactivity conferred on the triglyceride molecules by the double bonds(C═C) of the unsaturated acids, which allow them to react with the oxygen and with one another to form a polymeric network. The drying process is a succession and superposition of numerous reactions that can start by the auto-oxidation of C═C bonds of the fatty acid chain(s) leading to the formation of peroxidic compounds(R—O—O—R). The relatively unstable peroxide will give rise to the hydroperoxides, ROOH. The polymerization process can include the intermolecular coupling of radicals (elements with unpaired valence electron. making radicals highly chemically reactive towards other elements) with the formation of cross-linked (bond between respective polymer chains) structures. The formation of the polymer is characterized by the presence of C—O—C bands. In the following stage, the cross-links give rise to a highly stable network. The oxidation affects not only the structure of the dried linseed oil itself but also the surrounding materials. Polymerization of unsaturated linseed oil with clay molecules (for example Alumina: Al₂O₃ and silicates: SiO₄, with a small amount of potassium: K⁺, Sodium:Na⁺, Iron: Fe²⁺, Calcium: Ca²⁺and Magnesium: Mg²⁺) requires the presence of oxygen. During polymerization, the viscosity of the oil increases and its wetting properties decrease.

Since bamboo fiber is high in cellulosic content, it is believed that the presence of materials such as linseed oil, even when dispersed in the clay matrix facilitates bonds between the two materials. Clay material is made of alumina, silica, and some metal. During the polymerization, the components of the clay material react with the organic compound such as the linseed oil molecule at the double bonds to form a cross linked (a bond that links polymer together) structure. This bond is stable and difficult to break. It is also believed that the presence of metals, light, heat can accelerate the oxidation of unsaturated acids in the compound such as linseed oil. In certain embodiments, it is believed that one or more trace metals present in the clay can permit the clay to function as an autocatalyst in the presence of the fibers and organic compound as disclosed herein.

### Comparative Example I

The compression process for earth brick is employed. With water content, generally less than 10% by weight, the soil material is pressed into steel molds under pressure. The resulting bricks provide some pressure resistance and some durability but typically must be admixed with stabilizers such as cement to provide marginal strength.

Experiments are carried out to find out the average compressive strength of this type of bricks. The specimens were tested following the requirements of ASTM C 39 using press machine. Tables 1, 2, 3, 4 and 5 show the results of compressed earth brick test.

TABLE 1
STRESS AFTER 7 DAYS

| | Sample | | | | | |
|---|---|---|---|---|---|---|
| | 1 | 2 | 3 | 4 | 5 | Avg |
| Area (cm²) | 133 | 134 | 135.8 | 133 | 135.8 | |
| Mass (Dry), kg | 1.5 | 1.5 | 1.6 | 1.5 | 1.5 | |
| Load (KN) | 29.53 | 35.3 | 34.3 | 35.3 | 37.8 | |
| Stress (KN/cm²) | 0.22 | 0.26 | 0.25 | 0.27 | 0.28 | 0.32 |

TABLE 2
STRESS AFTER 14 DAYS

| | Sample | | | | | |
|---|---|---|---|---|---|---|
| | 1 | 2 | 3 | 4 | 5 | Avg |
| Area (cm²) | 134.4 | 133 | 131.6 | 130.2 | 128.8 | |
| Mass (Dry), kg | 1.4 | 1.5 | 1.4 | 1.4 | 1.4 | |
| Load (KN) | 41 | 36.4 | 46.6 | 46.6 | 44.1 | |
| Stress (KN/cm²) | 0.30 | 0.24 | 0.35 | 0.36 | 0.34 | 0.39 |

TABLE 3
STRESS AFTER 21 DAYS

| | Sample | | | | | |
|---|---|---|---|---|---|---|
| | 1 | 2 | 3 | 4 | 5 | Avg |
| Area (cm²) | 131.6 | 131.6 | 133 | 135.8 | 133 | |
| Mass (Dry), kg | 1.4 | 1.4 | 1.5 | 1.4 | 1.5 | |
| Load (KN) | 54 | 54 | 54 | 58.9 | 54 | |
| Stress (KN/cm²) | 0.4 | 0.4 | 0.4 | 0.43 | 0.4 | 0.4 |

TABLE 4
STRESS AFTER 28 DAYS

| | Sample | | | | | |
|---|---|---|---|---|---|---|
| | 1 | 2 | 3 | 4 | 5 | Avg |
| Area (cm²) | 133 | 135.8 | 131.6 | 135.8 | 131.6 | |
| Mass (Dry), kg | 1.4 | 1.5 | 1.4 | 1.5 | 1.4 | |
| Load (KN) | 46.6 | 54 | 46.6 | 54 | 46 | |
| Stress (KN/cm²) | 0.35 | 0.39 | 0.35 | 0.40 | 0.35 | 0.37 |

TABLE 5
STRESS AFTER 31 DAYS

| | Sample | | | | | |
|---|---|---|---|---|---|---|
| | 1 | 2 | 3 | 4 | 5 | Avg |
| Area (cm²) | 133 | 133 | 133 | 133 | 135.8 | |
| Mass (Dry), kg | 1.4 | 1.4 | 1.4 | 1.4 | 1.5 | |
| Load (KN) | 59 | 60 | * | 57 | 59 | |
| Stress (KN/cm²) | 0.44 | 0.45 | * | 0.43 | 0.43 | 0.44 |

The average compressive strength of bricks obtained is about 0.44 KN/(cm²) (640 psi). Because of this low compressive strength, bricks easily crack and fail.

### Example I

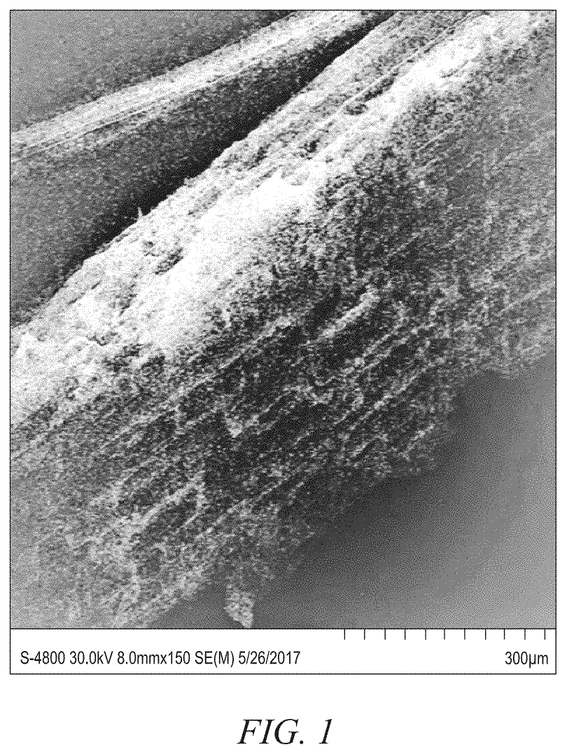

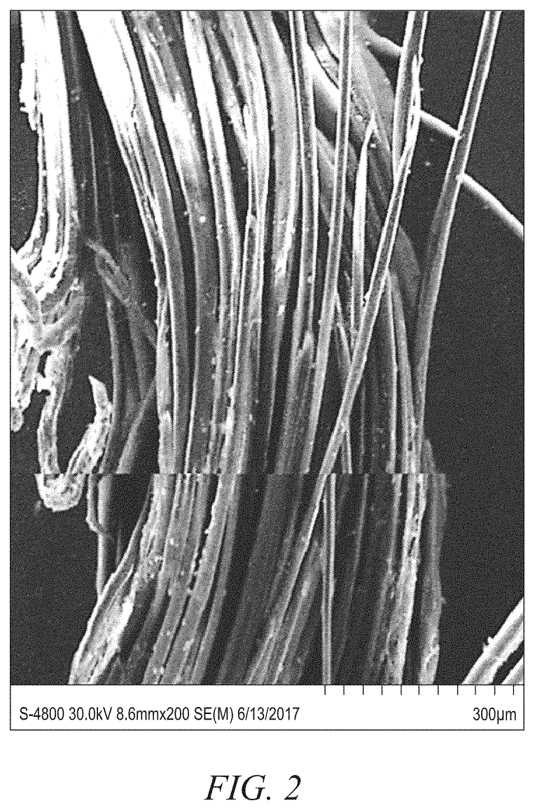

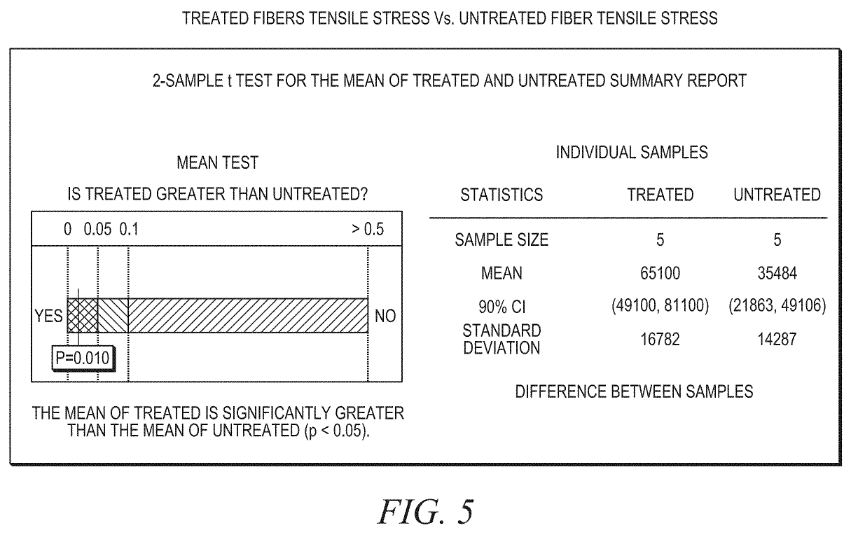

The bamboo specie (dry bamboo) used as specimens for this experimental work is known as Guadua Angustifolia (See FIG. 5-1a), which is part of the Guadua bamboo's family, and was provided by Santa Clara University, California. The Guadua bamboo is the largest and most economically important bamboo in the Western Hemisphere and is typical of bamboo found in various developing nations. It is a primary source of building material for urban and rural dwellings in many areas, especially in Colombia and Ecuador. The species have been shown to grow up to 25 meters in height and 22 centimeters in diameter, with each plant weighing up to 100 kilograms (Rojas de Sánchez, 2004). Bamboo specimens were taken from the internodes of a single culm. Preparing bamboo's fibers for testing was a two steps process involving mechanical extraction followed by chemical treatment.

Physical separation is employed to extract high quality fibers. Fibers used in testing were manually extracted from dried culms using a sharp knife and a small hammer. A rubber/wooden hammer was used to prevent damage. A shredder machine was also employed to extract part of the bamboo's fiber. The longitudinal direction of the fiber aligned with that of the culm and corresponds to the natural orientation of the bamboo cellulose fibrils. The cylindrical bamboo culms excluding the node portions were cut in the longitudinal direction into smaller chips. The average of cross-sectional dimensions at three locations along the length of each fiber were measured. The cross-sectional diameters obtained ranged from 0.7 to 1 mm. The length of the extracted fibers ranged between 30 and 45 cm.

The chemical treatment employed was an alkali treatment process which occurred in a two-step process. The bamboo fibers are first dried in an oven at 110° C. for 72 hours. The hydroxide (NaOH) and the pH indicator used to check the pH of the treated fiber were supplied by the Chemistry Department of the University of Detroit Mercy. The sodium hydroxide used has a high alkalinity (i.e., pH 12) characteristics.

Fibers were immersed in a 4% sodium hydroxide solution and soaked for 4 hours. After this treatment, the fibers were washed adequately with water until the alkalinity was neutralized. The pH of the material was tested using pH paper was to verify that fibers reach its neutral state (pH 7) as measured by the wash water. The fibers were then air-dried for 24 hours. and subsequently oven-dried for an additional 8 hours. The average diameter of the fibers after alkali treatment was measures to be 0.8 mm. The tensile test was performed on a single fiber using Instron Machine.

The type of soil employed was type SC (clayed sand) having 36% fine-grained (clay and silt) and 64% coarse-grained (sand). The sand was obtained from the site construction at the University of Detroit Mercy, and the clay was provided by DIGITALFIRE located in Ann Arbor (Mich.). The chemical composition and the mineralogical characterization of the clay are summarized in Table 6. Before testing, the engineered soil was stored and oven-dried for 24 hours at 110° C. Once the drying process was completed, the dried soils were classified. The soil was sieved to remove any impurities. The soil was first classified according to USCS (Unified Soil Classification System). Table 6 shows the results of the soil's properties. The Atterberg limit test was then performed on the fine grain soil to ascertain the plastic and liquid limit. The plastic and liquid limit were used for the final soil classification.

TABLE 6
REPRESENTATIVE CLAY CHEMICAL COMPOSITION

| | |
|---|---|
| CaO | 0.26% |
| MgO | 1.59% |
| K₂O | 4.15% |
| Na₂O | 0.38% |
| P₂O₅ | 0.22% |
| TiO₂ | 1.09% |
| Al₂O₃ | 15.51% |
| SiO₂ | 64.95% |
| Fe₂O₃ | 7.05% |
| LO₁ | 4.8% |

TABLE 7
SOIL PROPERTIES

| | |
|---|---|
| Liquid Limit | 30.5% |
| Plastic Limit | 20.25% |
| Plasticity index | 10.25% |
| Moisture Content: | 0.8% |
| Unit weight | 104ib/ft³ |
| Sand | 64% |
| Fined-soil | 36% |

The structural component such as the brick can contain a suitable organic compound such as a vegetal oil. Non-limiting examples include linseed oil, palm oil, and peanut oil and the like. It is contemplated that in the process of oil extraction, considerable oil waste is produced annually and that such material can compose at least a part of the oil component.

The organic compounds such as linseed oil do not mix spontaneously with water. The ability to repel water can be exploited to reduce the water absorption of brick, thereby protecting the fiber embedded in the clay. Molecules of water are strongly attracted to each other because they are polar (a positive charge at one end and a negative charge at the other end). Oil and water molecules are not attracted to each other because the molecules of the organic component are non-polar (no charge) and/or hydrophobic (hate water). Because of this, the organic component such as oil and water typically do not mix unless a suitable surfactant such as a detergent is added to the composition. The molecules of organic compound such as oil fill the voids present in the soil leaving little room for the incurion of water into the formed structural component such as bricks. In specific embodiments, linseed oil is employed.

The linseed oil utilized in this test was provided by Sunnyside Corporation (Illinois, US). Oils employed in certain embodiments can be classified as triglycerides, i.e., esters of glycerol combined with three fatty acids. They can be grouped into non-drying, semi-drying and drying oils. Drying oils are highly unsaturated oils, consisting of fatty acids having two or three double bonds. Linseed oil is an example of drying oil. Linseed oil can be colorless or yellow and is extracted from the seeds of the flax plant (Linum usitatissimum, Linaceae). It is believed to have a high drying property due to a higher concentration of linolenic acid and to exhibit hydrophobic properties as well as to have the capacity to penetrate and impregnate cellulosic material. Upon drying, the material provides good protection against moisture and water diffusion.

Linseed oil has a significant amount of a-linolenic acid, which has a distinctive reaction with oxygen in the air. It is mainly composed of about 53% linolenic acid, 18% oleic acid, 15% alpha-linoleic acid, 6% palmitic acid, and 6% stearic acid. Table 8 compares the composition of linseed oil with other drying oils.

TABLE 8
FATTY ACID COMPOSITIONS OF SOME DRYING OILS

| Oil | Palmitic | Stearic | Oleic | Linoleic | Linolenic |
|---|---|---|---|---|---|
| Linseed | 6-7 | 3-6 | 14-24 | 14-19 | 48-60 |
| Walnut | 3-7 | 0.5-3 | 9-30 | 57-76 | 2-16 |
| Poppyseed | 10 | 2 | 11 | 72 | 5 |
| Tung | 3 | 2 | 11 | 15 | 3 |

The following is a general formulaic depiction of the riglyceride present in linseed oil:

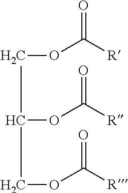

wherein R′ is:

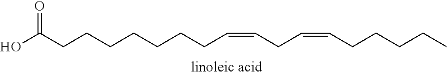 [SMILES: CCCCC/C=C\C/C=C\CCCCCCCC(=O)O]

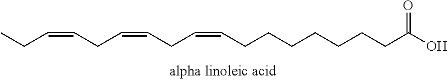 [SMILES: CC/C=C\C/C=C\C/C=C\CCCCCCCC(=O)O]

### R″ is

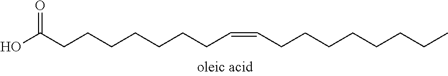 [SMILES: CCCCCCCC/C=C\CCCCCCCC(=O)O]

### R′″ is

### Example II

The effects of the chemical treatment employing the hydroxide outlined in Example I on the surfaces of fibers were examined using a scanning electron microscope (SEM). A SEM (S-4800, Hitachi, voltage 10 kv). was used to take images of Guadua bamboo fibers surface, to evaluate the changes on its surface due to the sodium hydroxide' s treatment. The treated and untreated specimen, about linch long and 0.01 inch in diameter, was put on a conductive cobber's sheet and placed into the SEM. Results of the examination are shown in FIGS. 1 and 2. As can be seen, treated fibers show more exposed fiber, uniformity and cleanliness. Without being bound to any theory, it is believed that by between the hydroxide and lignin presentin the fibers contributes to exposure of fiber surface area and renders more of the molecular structure available for reaction when the fibers are brought into contact with the with surrounding clay soil matrix. Additionally, it is believed that the removal of lignin and impurities such as aliphatic wax caused by exposure to the hydroxide exposes cavities in the fiber. It has been found, quite unexpectedly that the aliphatic wax present in and on the fibers can be incompatible with many types of associated matrices. Thus, removal of some or all of the aliphatic wax aliphatic wax can result in the better bond formation and interaction between the fiber material and the matrix.

### Example III

To study the influence of treatments on mechanical properties of fibers, tensile tests were carried out on untreated and treated fibers. The fibers employed are those outlined in Example I. The stress at failure and the modulus of elasticity were all determined based on the tensile test data. The tensile test was performed on a single fiber to find their tensile modulus, ultimate strength at failure following the ASTM D3379-75/ASTM C1557-14 standard.

A total of five untreated fibers and five fibers treated according to the process outlined in Example II were selected and verified as undamaged. A digital caliper was used to determine the section of a single fiber. The section of the fiber was measured at three different points along the length of each fiber specimen. The variation in the diameter was negligible. Mean diameter was determined and used in all calculations.

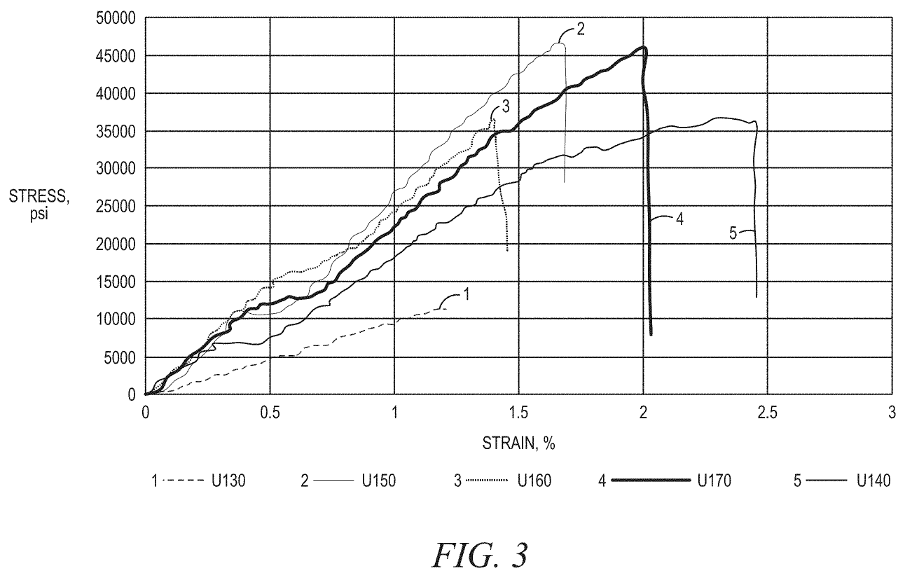

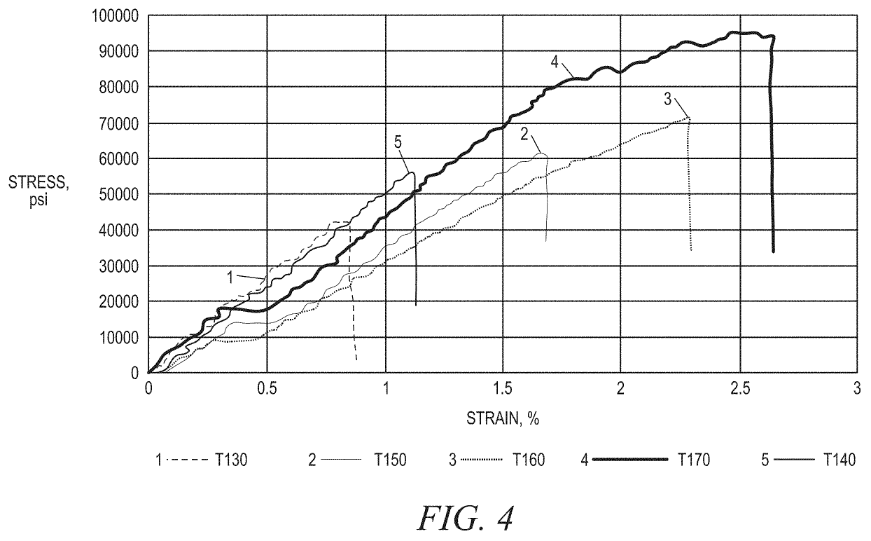

An electronic weighing machine (0.001 g accuracy) was used to weigh the fibers. The fibers weighed from 2×10⁻⁴ lb to 6.5×10⁻⁴ lb. The experiments were conducted on the universal testing machine (Intron 8511.4) under axial loading. The crosshead speed was 2 mm/min with a 100 N load cell. Fibers of gauge length 13, 14, 15, 16, 17 cm were tested. The specimen was placed at the center of the cross-head to get accurate results. The ultimate load carried by the set of fibers and the ultimate stress before failure are measured. The stress vs. percentage strain is shown in FIGS. 3 and 4. The tensile strength is calculated from the ultimate load and the cross-sectional area of fibers (The cross-sectional area of a fiber is calculated using the average diameter determined above.) following the formula:

$$σ = \frac{F}{A} ,$$

where σ is the stress; F is
the force at failure; A is the fiber cross sectional area in in². The strain:

$$ɛ = \frac{Δ L}{L} ,$$

the Young modulus:

$$E = \frac{σ}{ɛ} .$$

The Instron and press machine used for testing were calibrated using a dial. The results are presented in Table 9 for treated and untreated Guadua bamboo fibers.

TABLE 9
TENSILE STRENGTH AND YOUNG MODULUS
OF TREATED AND UNTREATED FIBER

| | TREATED | | UNTREATED | |
|---|---|---|---|---|
| | Tensile strength | | Tensile strength | |
| Specimen | at failure (psi) | E (psi) | at failure (psi) | E (psi) |
| 1 | 90,221 | 35,571.27 | 46,063.00 | 23,147.24 |
| 2 | 56,638.00 | 50,479.50 | 36,340.00 | 14,796.42 |
| 3 | 61,457.00 | 37,066.95 | 46,804.00 | 28,229.19 |
| 4 | 71,357.00 | 31,160.26 | 36,695.00 | 26,136.04 |
| 5 | 45,827.00 | 50,993.99 | 11,520.00 | 9,616.03 |
| Avg. | 65,100.00 | 41,054.39 | 35,484.40 | 20,384.98 |

This suggests that the incorporation of treated bamboo fiber into brick could likely improve the tensile and the bending strength of the composite.

The variability of results in FIGS. 3 and 4 is related to bamboo being a natural material with anisotropic characteristics. It is believed that this is because the outer part of the culm has a far higher specific gravity than the inner part. The specific gravity of bamboo varies between 0.4 and 0.8. In other words, the density of bamboo increases from inside to outside. The percentage of fibers also increases from inside to outside and from the bottom to the top of the culm. Density and, therefore strength, go up from inside to outside, from bottom to top. Therefore, fibers from the same culm can vary in properties. The nodal portion with about 20% of weight has shorter fibers, lower cellulose content, and discontinuity. Consequently, the nodal portion has lower strength properties than the inter-nodal portion.

Without being bound to any theory, it is believed that the alkaline fiber treatment as disclosed herein eliminates several hemicelluloses and/or lignin and can erode the essential elements such as gamma, beta alpha cellulose resulting in an increase in maximum strain thus providing optimum tensile strength.

It is also believed that the alkaline treatment as disclosed herein may introduce some reactive groups into the structure of the fibers and can provide the fibers with higher extensibility through partial removal of lignin and hemicellulose that otherwise would act as glue-like materials to decrease mechanical strength.

### Example IV

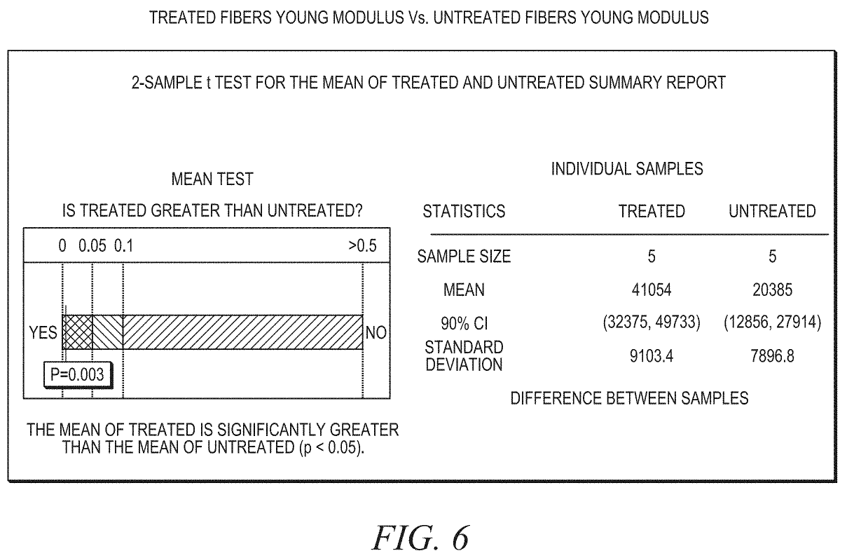

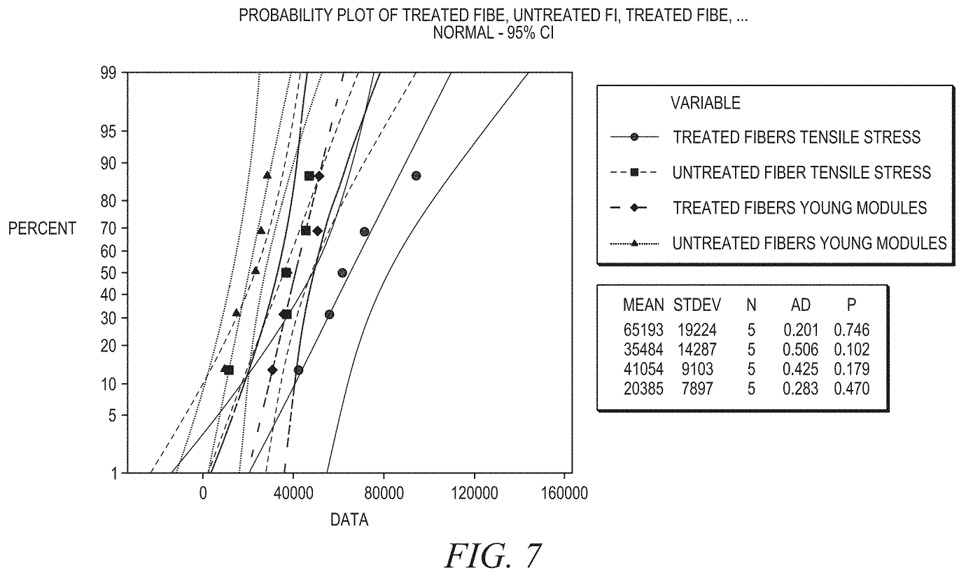

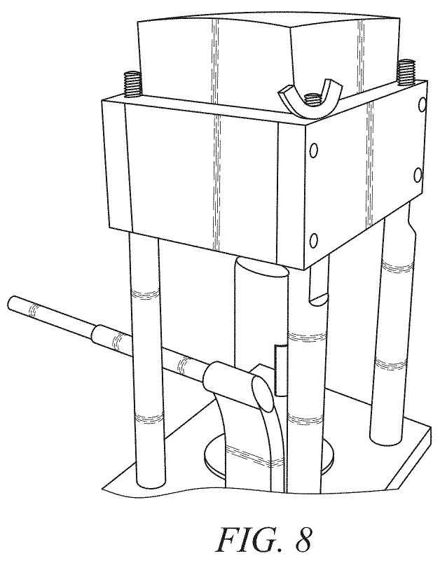

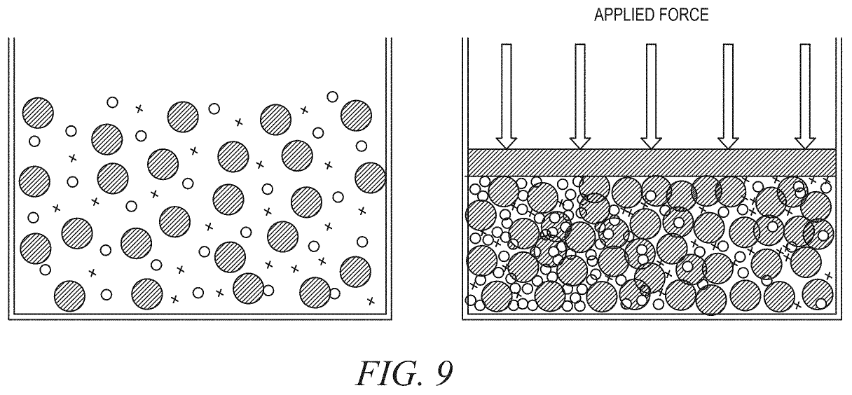

Statistical analysis to determine whether fiber treated according to the process outlined in herein and material incorporating the same produced a significant result in terms of strength and water resistance of the resulting structural component. Samples treated according to the process outlined in Example II were randomly selected to ascertain whether mean of failure stress of the untreated fibers and that of the treated fibers are equal, or the mean of stress at failure and modulus of rupture of treated bamboo fiber is higher than the untreated one. Data for tensile stress analysis is set forth in FIG. 5 and Young's module is set forth in FIG. 6 Verification of Normality is presented in FIG. 7.

The normal probability plot in the FIG. 7 shows that the plotted points for both treated and untreated fiber fall approximately along the straight line. Therefore, the assumption of normality is appropriate. The P value (which is the probability that null hypothesis is true) for both stresses at failure and modulus of elasticity is less than 0.05. Since the P-value is less than 0.05, it is concluded that the treated fiber has greater tensile strength and modulus of rupture than untreated fiber. Therefore, the alkaline treatment improves the tensile strength of Guardia bamboo fiber.

### Example V

Water resistance was analyzed to study the influence of both organic components such as linseed oil and NaOH treatment on the ability of the fiber to resist water penetration. Bamboo fibers as describe in Example II were first dried in an oven at 110° C. for seven days to reduce its moisture content from 10% to about 0.8%. Five treated (NaOH, Linseed oil, Linseed oil & NaOH) specimens were prepared for this test, and five untreated specimens were prepared for comparison. Randomly selected, measured and weighed bamboo fibers were immersed in Linseed oil for twenty-eight days. After which, they were removed and exposed to ambient air until no trace of linseed oil could not be detected on visual inspection. The treated fibers were then immersed in water for 24 hours after which they were removed and exposed to air for about 30 seconds. The water absorption tests was conducted following the ASTM C20 standard. The results of the water absorption test are presented in Tables 10, 11, 12 and 13. The calculation of moisture content was done as follows:

$$MC = \frac{( Wt - Wd )}{Wd} * 100 = \frac{{W}_{w}}{{W}_{d}} * 100$$

$$Wd \text{:} Mass of dry fiber$$

$$Wt \text{:} Mass of wet fiber$$

$$Ww \text{:} Mass of water$$

TABLE 10
WATER ABSORPTION OF OIL-TREATED FIBER
OIL

| | Wo | Wwet | Wwater | MC (%) |
|---|---|---|---|---|
| 1 | 0.0015 | 0.0020 | 0.0005 | 33.33 |
| 2 | 0.0016 | 0.0020 | 0.0005 | 31.61 |
| 3 | 0.0009 | 0.0012 | 0.0003 | 33.33 |
| 4 | 0.0009 | 0.0011 | 0.0003 | 31.17 |
| 5 | 0.0024 | 0.0032 | 0.0008 | 33.33 |
| Avg | 0.0014 | 0.0019 | 0.0005 | 32.55 |
| STD | | | | 1.07 |

TABLE 11
WATER ABSORPTION OF TREATED (NAOH & OIL) FIBER
NaOH & Oil

| | Wo | Wwet | Wwater | MC (%) |
|---|---|---|---|---|
| 1 | 0.0011 | 0.0015 | 0.0004 | 31.81 |
| 2 | 0.0012 | 0.0015 | 0.0004 | 30.43 |
| 3 | 0.0013 | 0.0017 | 0.0004 | 32.30 |
| 4 | 0.0011 | 0.0014 | 0.0004 | 33.33 |
| 5 | 0.0012 | 0.0016 | 0.0004 | 33.33 |
| Avg | 0.0012 | 0.0016 | 0.0004 | 32.24 |
| STD | | | | 1.20 |

TABLE 12
WATER ABSORPTION OF TREATED(NAOH) FIBER
NaOH

| | Wo | Wwet | Wwater | MC (%) |
|---|---|---|---|---|
| 1 | 0.0011 | 0.0015 | 0.0004 | 31.81 |
| 2 | 0.0012 | 0.0015 | 0.0004 | 30.43 |
| 3 | 0.0013 | 0.0017 | 0.0004 | 32.30 |
| 4 | 0.0011 | 0.0014 | 0.0004 | 33.33 |
| 5 | 0.0012 | 0.0016 | 0.0004 | 33.33 |
| Avg | 0.0012 | 0.0016 | 0.0004 | 32.24 |
| STD | | | | 1.20 |

TABLE 13
WATER ABSORPTION OF DRY FIBER
No Treatment

| | Wo | Wwet | Wwater | MC (%) |
|---|---|---|---|---|
| 1 | 0.0019 | 0.004 | 0.0021 | 110.52 |
| 2 | 0.00295 | 0.006 | 0.00305 | 103.38 |
| 3 | 0.00285 | 0.0057 | 0.00285 | 100 |
| 4 | 0.0022 | 0.0048 | 0.0026 | 118.18 |
| 5 | 0.00195 | 0.004 | 0.00205 | 105.12 |
| Avg | 0.00237 | 0.0049 | 0.00253 | 107.44 |
| STD | | | | 6.35 |

The results show a decrease in water absorption by bamboo fiber due to alkaline treatment and by combined linseed oil-alkaline treatment with fibers treated by the combined linseed oil and alkaline treatment demonstrating better water resistance. It is posited that alkaline reacts with the cellulose, especially the —OH group free to interact with water, thus lowering the moisture absorption of the respective fiber. Additionally, it is posited the linseed oil molecules imparted into contact with the respective fibers and water molecules in the surrounding environment are not attracted to each other because linseed oil molecules are non-polar (no charge) and hydrophobic whereas water is polar.

### Example VI

Composites are materials consisting of two or more distinct phases with recognizable interphase were investigated. In a composite, as the term is used herein, the discontinuous phase is embedded in a continuous phase. The two heterogeneous phases are in intimate contact with each other on a microscopic scale. In structural components such as embodiments of the composite brick as disclosed herein the composite broadly comprises clay and fiber, representing the continuous and discontinuous phrases respectively.

The importance of interface in compounds made according to the process as disclosed herein was explored experimentally. The interphase is a region where the fiber and matrix phases are chemically or mechanically combined or attached and exhibits a bonding region where there is a discontinuity. No component taken in isolation has its property. In the structural component as disclosed herein an effective interface is one in which load originating from the matrix is transferred to the fibers. Ideally, the interface should provide strong adhesion between fibers and matrix material. The mechanical properties of the resulting composite will depend, at least in part on the individual properties of both elements in contact with one another. The type, amount and strength of bonding between fibers and matrix plays an important role in the material performance of the resulting structural component. At least a portion of stress transfer will occur along the fiber/matrix interface and, in consequence, will depend on the bonding between the fiber and the matrix.

The discontinuous phase made up of the fibers is usually stronger than the continuous phase and is called a reinforcement, whereas the continuous phase is called matrix. Therefore, the stress is transferred from the “weak” matrix to the “strong” fiber and from fiber to fiber through the matrix, as well. In the structural component as disclosed herein the matrix material is of a sufficient type and volume to support the associated fibers and maintain the fibers in the proper position relative to the matrix as well as protecting the fibers from damage. Without being bound to any theory, it is believed that properties of the structural component composite as disclosed herein are based, at least in part, on the microstructure and performance of interphase between a reinforcing fiber and matrix. It is believed that, due to their higher load resistance, the fibers as disclosed herein increase the amount of stress that the associated composite can bear before failure. It is also believed that the interface, at least in part, controls the interactions between fiber and matrix and thus also the mechanical property of resulting structural composites.

In order to analyze this, the effects of fiber content and fiber length in clay matrix were studied. Without being bound to any theory, it is believed that, when the fiber length is 15 mm or greater, one or both tensile and flexural strength of fiber-reinforced composite increase with increasing fiber length. To assess this, bamboo fibers as described and prepared in Examples II and III were cut into pieces ranging from 15 to 25 mm. The structural component composite bricks required an amount of bamboo fiber and clay to be mixed for each volume fraction of the fibers. The volume fractions employed were varied between 0% to 7% fiber to matrix with the matrix being that which was outlined in Example I.

The production of the composite brick sample was carried out in three steps. Since the soil is engineered, the clay and sand were first homogenized in different proportions in a blender. Mixing water/linseed oil was weighed and added to the mixture at a ratio of 8% (by weight) to provide a suitable composite plasticity clay material. The entire mixture was then blended to homogeneity as indicated by visual inspection.

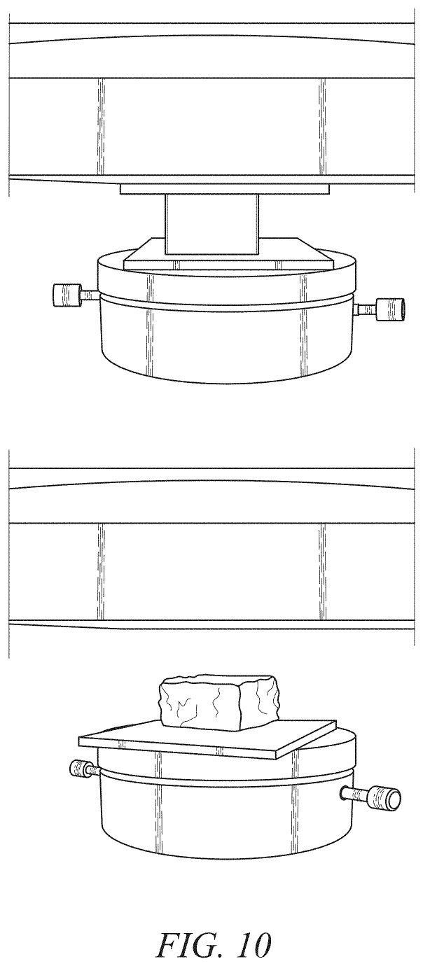

Treated bamboo fibers (10 to 25 mm in length) prepared according to the procedure outlined in Example II, were manually added to resulting mixture portions at weight ratios between 0% and 7%. The resulting respective mixtures were poured into individual molding boxes having dimensions 7in×5in×3in. Each mixture was, then, subjected to a maximum pressure was applied using a hydraulic jack machine such as as depicted in FIG. 10. The respective molded mixtures were each subjected to uniform maximum force as read by a suitable force measurements device. The respective specimens were each then removed from the machine by applying a force at the bottom of the associated mold. The specimens were the stored and dried at room temperature.

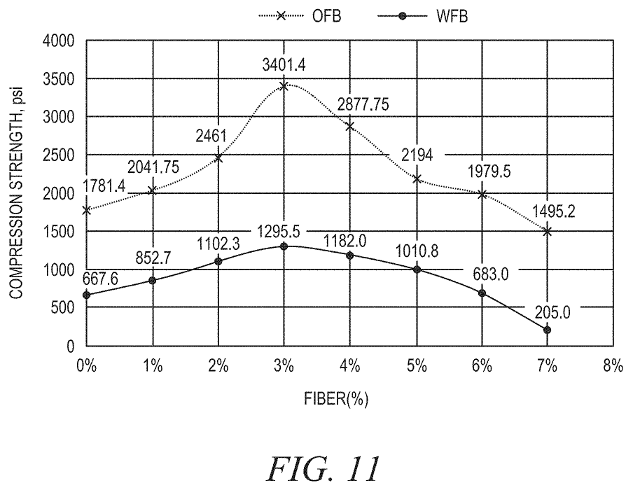

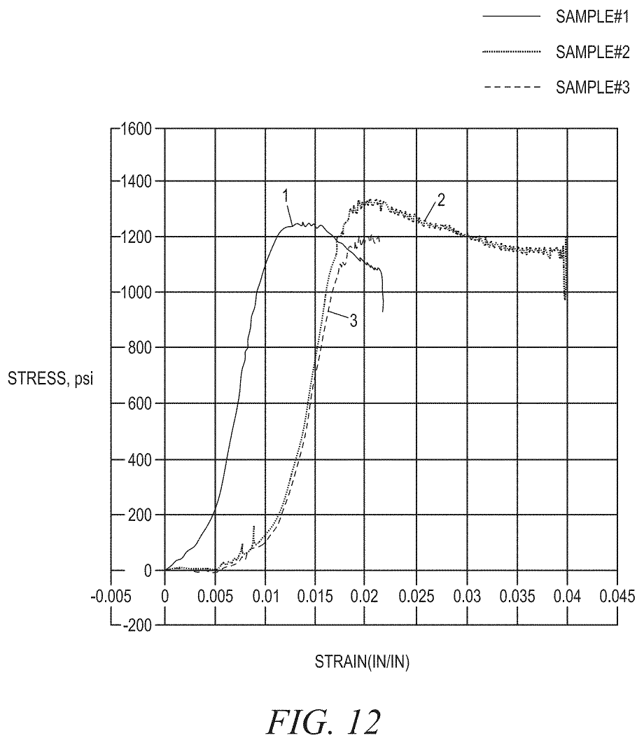

The structural components as disclosed herin can be formed by a process that includes soil compaction in which suitable equipment is employed to compress the matrix material, i.e. the soil composition in which the fiber is distributed into a smaller volume, thus increasing the dry unit weight, reducing the void and improving the engineering properties of the resulting structural component. When the soil composition is compacted into shape, the particles are moved closely in contact with one another and become denser as is illustrated in FIG. 11. During this compaction process, more particles brought in contact with one another with fewer voids and the amount of water that can be held in the construct such as the brick is reduced. Additionally, compaction reduces the total surface area and therefore increased the density and the shear strength of the resulting structure.

### Comparative Example II

In order to ascertain the effects of the process outlined in Example VI in producing bricks as compared with the fired bricks, the following study was conducted. Properties of bricks are affected by physical, chemical and mineralogical changes. Strength and water absorption of the brick are highly affected by firing temperature. The firing process significantly increases the mechanical and physical properties of the clay bricks. However, the additional strength and waterproofing gained through the sintering process comes at a high cost. The firing temperature commonly ranges between 1700° F. (960° C.) and 2400° F. (1320° C.) and take 60 to 80 hours. The firing time in a klin and the peak temperature depend on the properties of the plastic clay. Fired clay bricks suffer from the rising price of energy and environmental problems such as high energy usage and carbon dioxide emission.

Without being bound to any theory, it is believed that the action of kiln heat leads to a sintering process that causes the particulate clay material to fuse and thus develop strong ceramic bonds in the fired clay bodies. In this process, the green ceramic is heated to a high temperature treatment using a controlled heat treatment. The sintering process contributes to density in the finished brick. During firing, the clay material dehydrates and clay particles and other fluxing materials react with coarser particles to produce a stable and hard bond.

Without being bound to any theory, it is believed that the properties of fired ceramic materials depend on the types of atoms, the types of bonding, and the arrangement of the atoms. The ceramic is characterized by a combination of covalent and ionic bonds. This mixed bonding holds the atoms together. The covalent bonds in ceramic materials like clay tends to be directional (formed when the bonds between atoms in a covalently bonded material form specific angles); this results in limited ductility. Without being bound to any theory, it is believed that these bonds are responsible for its high compressive strength. Porosity is an important defect in ceramics. The presence of pores is usually detrimental to one or more mechanical properties since pores provide a location from which a crack can grow and is one of the reasons why cracks can propagate and why fired ceramic materials are brittle under tensile load.

Generally speaking in fired ceramic brick materials, the larger the imperfection (level of porosity) the smaller the tensile stress the material can handle. Griffith equation:

$${σ}_{f} = \sqrt{\frac{EM}{π * C}} .$$

This expression describes the interrelation between three important aspects of the fracture process: the material fracture toughness M; the applied stress σ_{ƒ}: and the size of the flaw(imperfection).

### Example VII

A comparison of conventional fired bricks prepared according to Comparative Example II and bricks prepared according Example VI was undertaken. Comparison tests took place 45 days after the composites outlined in Example VI were manufactured and dried and were performed according to the procedure outlined in ASTM C39/ASTM C67. The Crushing test was carried out at the University of Detroit Mercy, Mechanical Engineering Laboratory at room temperature. The equipment used was the Uniaxial Compression Machine with a maximum capacity of 400,000 Lbf.

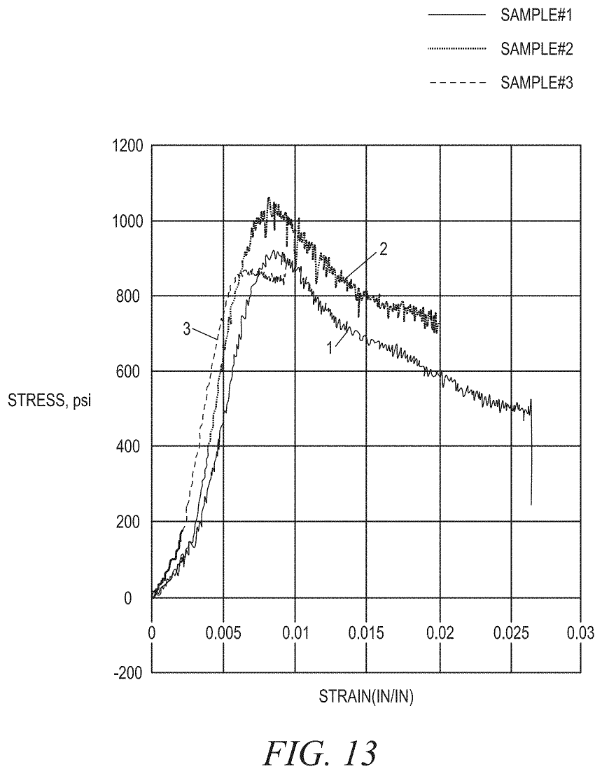

At the outset, the respective bricks were measured and the dimensions of each brick unit were recorded. Each specimen was carefully placed in between the upper and base metal plates (approximately 7″×5″ in dimensions) in the compression machine to distribute the load. The speed of the moving head of the testing machine was set at 3 mm per minute. The load was applied till failure occurred. The maximum compressive strength of each specimen was obtained by dividing the load at failure by the bed surface area. FIG. 12 illustrates a representative brick before and after crushing. The maximum compressive strength obtained for different samples having different fiber content is set forth in Tables 14 and 15. For solid bricks, the ASTM standards require the minimum compressive strength for various grades as given in FIG. 13. It has been found that fiber contents of 3 to 5% yielded high compressive strength and modulus of elasticity. Calculation of compressive strength was made by the following equation:

$$σ = \frac{W}{A}$$

TABLE 14
COMPRESSIVE STRENGTH OF WATER-CLAY BRICK UNITS
Percentage fiber in brick

| Sam- | | | | | | | | |
|---|---|---|---|---|---|---|---|---|
| ple | 0% | 1% | 2% | 3% | 4% | 5% | 6% | 7% |
| 1 | 628.0 | 847.0 | 1073 | 1305 | 1210 | 1024.0 | 685.0 | 210 |
| 2 | 634.0 | 852 | 1027 | 1368 | 1225 | 1021.0 | 702.0 | 198 |
| 3 | 624.0 | 827 | 1098.0 | 1298 | 1155 | 997.0 | 685.0 | 187 |
| 4 | 619.0 | 865.0 | 1108.0 | 1302.0 | 1175.0 | 1002.0 | 664.0 | 204.0 |
| 5 | 632.0 | 846.0 | 1101.0 | 1289.0 | 1189.0 | 1010.0 | 679.0 | 206.0 |

TABLE 15
COMPRESSIVE STRENGTH OF OIL-CLAY BRICK UNITS
Percentage of Fiber in Brick

| Sample | 0% | 1% | 2% | 3% | 4% | 5% | 6% | 7% |
|---|---|---|---|---|---|---|---|---|
| 1 | 1784.0 | 2010 | 2450 | 3405.0 | 2865.0 | 2279 | 1870 | 1489.0 |
| 2 | 1799.0 | 2043.0 | 2468.0 | 3397.0 | 2897 | 2256.6 | 1979.0 | 1501.0 |
| 3 | 1780.0 | 2048.0 | 2455.0 | 3402.0 | 2886.0 | 2215 | 1986.0 | 1482.0 |
| 4 | 1769.0 | 2046.0 | 2456.0 | 3398.0 | 2881.0 | 2189.0 | 1970.0 | 1507.0 |
| 5 | 1775.0 | 2030.0 | 2465.0 | 3405.0 | 2879.0 | 2199.0 | 1983.0 | 1497.0 |
| Avg | 1781.4 | 2041.8 | 2461.0 | 3401.4 | 2877.8 | 2194.0 | 1979.5 | 1495.2 |
| STD | 11.3 | 8.1 | 6.5 | 3.8 | 9.0 | 7.1 | 7.0 | 9.9 |

TABLE 16
PHYSICAL REQUIREMENTS FOR
CLAY BRICKS (ASTM C 62)

| | | | | | Maximum MC | |
|---|---|---|---|---|---|---|
| Minimum Compressive | | | | | (5 hrs. boiling and | |
| strength psi (Mpa) | | | | | 24 hrs. submersion) | |
| Desig- | Average of | | Indi- | | Average of | Indi- |
| nation | 5 bricks | | vidual | | 5 bricks | vidual |
| Grade SW | 3000 | (20.7) | 2,500 | (17.2) | 17.7 | 20 |
| Grade MW | 2,500 | (17.2) | 2,200 | (15.2) | 22 | 25 |
| Grade NW | 1,500 | (10.3) | 1,250 | (8.6) | no limit | no limit |

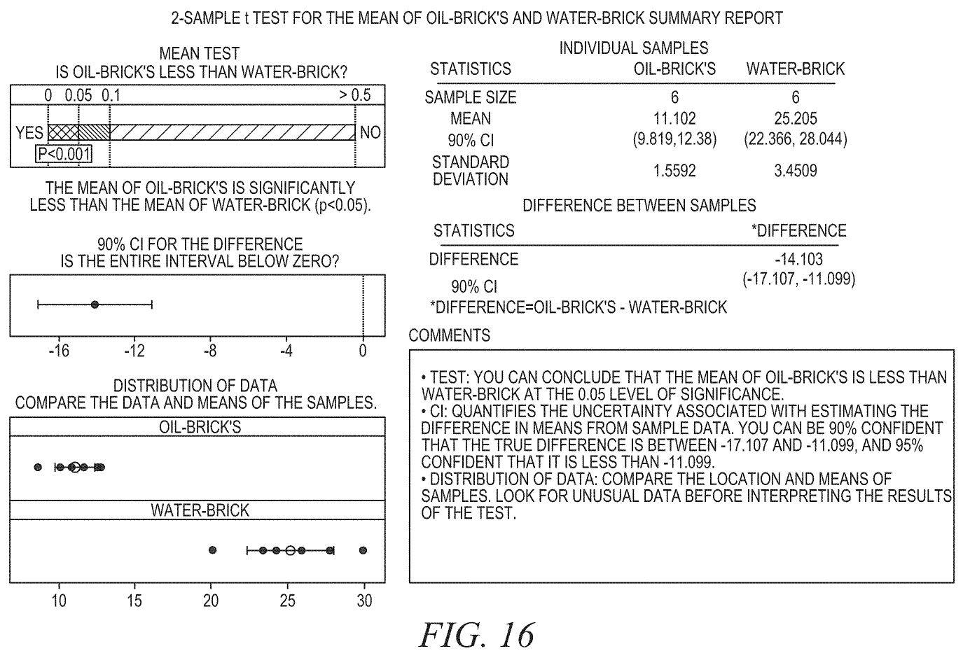

The analysis report depicted in FIG. 16 shows that the P-value for linseed oil-bending and water-bending is less than 0.05. Since the P-value is less than 0.05, we reject the null hypothesis and conclude that the linseed oil-fiber brick has higher bending strength than water-fiber brick. Therefore, the substitution of water by linseed oil has treatment significantly improves the flexural strength of the brick. From this result, we can conclude that linseed oil is compatible with treated fiber since their simultaneous incorporation has improved the bending and compression strength of the brick. In other words, the interaction between treated fiber, using NaOH and linseed oil is constructive.

### Example VIII

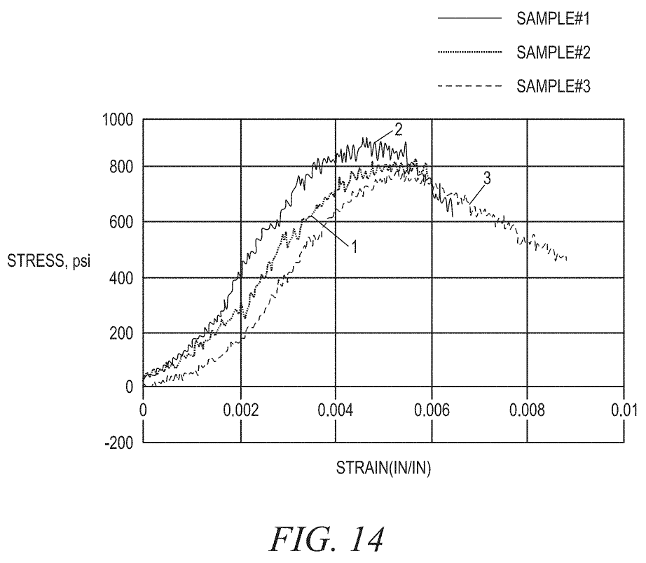

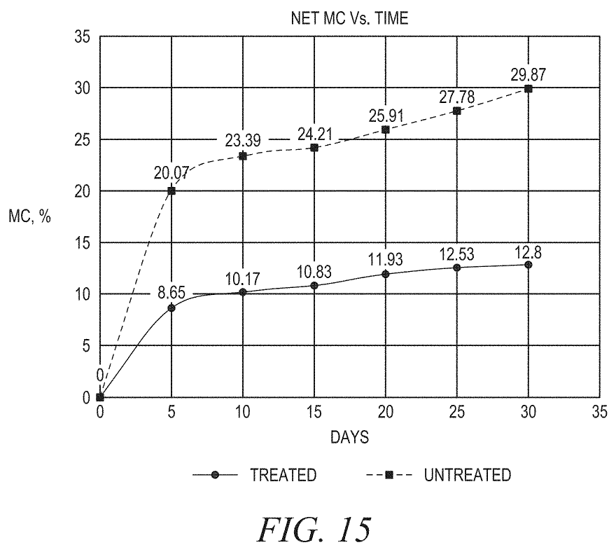

To check if the composite brick is isotropic, we ran the compression test on 5% fiber brick in its three directions and compare the resulting Young modulus values. The tests were performed in accordance with ASTM C67. Data is collected in Table 17 and is graphically depicted in FIGS. 14, 15 and 16 which present the strength and stress strain curves for the three dimensions of a brick having 3% fiber as prepared according to the foregoing examples.

The brick was found to behave linearly up to about 80% of the ultimate failure load after which the behavior became nonlinear. The summary of the results including the maximum load at failure and the modulus of elasticity is given in Table 17 supporting the conclusion that the composite brick can be considered isotropic.

TABLE 17
YOUNG MODULUS IN ALL DIRECTIONS
E in 3 directions

| | Thickness | Length | Width |
|---|---|---|---|
| Sample | E (psi) | | |
| 1 | 215,000 | 230,000 | 235,000 |
| 2 | 218,950 | 228,970 | 228,000 |
| 3 | 219,820 | 225,000 | 230,000 |
| Avg | 217,923 | 227,990 | 231,000 |
| STD | 2,568 | 2,640 | 3,605 |

### Example IX

The effect of water absorption/resistance on bricks prepared according to the process outlined herein was analyzed. Water resistance is considered as one of the most important properties affecting brick durability and longevity. Greater water impermeability can provide bricks with greater durability and resistance to the natural environment. Despite previous research, water or moisture content of brick material is still of great concern. To investigate the influence of linseed oil on moisture absorption, ten specimens were made according to the process outlined in the foregoing Examples.

To analyze the effect of water absorption on brick construct structures, specimens of bricks prepared according to the process outlined herein were divided into two parts, namely the linseed oil mixed bricks and control specimens made without linseed oil. Specimens for this test were made by mixing dry soil and linseed oil in a ratio of 8% in mass using a mixing machine. The mixture was poured into the compressing machine and pressed. The specimens were dried in the manner outlined previously and weighed after drying with the respective dry weights recorded.

The dried bricks were submerged in water at room temperature. The water absorption of brick was evaluated after 5, 10, 15, 20, 25, and 30 days. The water absorption test was conducted according to the provisions of ASTM C20/C67. Each speciment was removed from the water, wiped off and weighed with the weighing of each specimen completed within one minute after removing from water. The between the original dry weight and the weight after submersion provides the data regarding the the amount of water absorbed by the respective bricks. The results outlined in Table 18 and the graphic data provided in FIG. 16 support the unexpected discovery that the inclusion of an organic compound such as linseed oil provides bricks exhibiting decreased water absorption.

The calculation of water absorption was performed using the following equation:

$$Absorption ( \% ) = 100 ( \frac{{W}_{s - {w}_{d}}}{{W}_{d}} )$$

$${W}_{d} = dry weight of the specimen ( lb ) ;$$

$${W}_{s} = Weight of the specimen after submersion in water ( lb ) .$$

TABLE 18A
WATER ABSORPTION VS. TIME FOR OIL-BRICK AND COMPOSITES
(MC %)

| | | | Day 5 | | Day 10 | | Day 15 | | Day 20 | | Day 25 | | Day 30 | |
|---|---|---|---|---|---|---|---|---|---|---|---|---|---|---|
| Treatment | Sample | Dry Mass | Mass | MC, % | Mass | MC. % | Mass | MC. % | Mass | MC. % | Mass | MC. % | Mass | MC. % |
| Linseed | 1 | 21.76 | 23.23 | 6.76 | 23.25 | 6.85 | 23.27 | 6.94 | 24.20 | 11.21 | 24.32 | 11.76 | 24.36 | 11.95 |
| Oil | 2 | 16.84 | 18.20 | 8.08 | 18.93 | 12.41 | 18.96 | 12.59 | 18.97 | 12.65 | 18.99 | 12.77 | 19.00 | 12.83 |
| | 3 | 18.84 | 20.42 | 8.39 | 20.44 | 8.49 | 20.45 | 8.55 | 20.60 | 9.34 | 21.00 | 11.46 | 21.16 | 12.31 |
| | 4 | 22.09 | 24.12 | 9.19 | 24.73 | 11.95 | 24.85 | 12.49 | 24.90 | 12.72 | 24.92 | 12.81 | 24.94 | 12.90 |
| | 5 | 19.8 | 21.95 | 10.86 | 22.01 | 11.16 | 22.49 | 13.59 | 22.52 | 13.74 | 22.54 | 13.84 | 22.57 | 13.99 |
| Avg MC, % | | | | 8.65 | | 10.17 | | 10.83 | | 11.93 | | 12.53 | | 12.80 |
| STD | | | | 1.51 | | 2.40 | | 2.91 | | 1.70 | | 0.52 | | 0.77 |

TABLE 18B
WATER ABSORPTION VS. TIME FOR OIL-BRICK AND COMPOSITES
(MC %)

| | | | Day 5 | | Day 10 | | Day 15 | | Day 20 | | Day 25 | | Day 30 | |
|---|---|---|---|---|---|---|---|---|---|---|---|---|---|---|
| Treatment | Sample | Dry Mass | Mass | MC, % | Mass | MC. % | Mass | MC. % | Mass | MC. % | Mass | MC. % | Mass | MC. % |
| Water | 1 | 21.41 | 25.30 | 18.17 | 26.00 | 21.44 | 26.34 | 23.03 | 26.59 | 24.19 | 26.95 | 25.88 | 27.39 | 27.93 |
| Water | 2 | 20.46 | 24.60 | 20.23 | 25.41 | 24.19 | 25.51 | 24.68 | 25.88 | 26.49 | 26.01 | 27.13 | 26.13 | 27.71 |
| Water | 3 | 20.08 | 24.07 | 19.87 | 24.52 | 22.11 | 24.77 | 23.36 | 25.21 | 25.55 | 25.55 | 27.24 | 25.84 | 28.69 |
| Water | 4 | 20.49 | 24.84 | 21.23 | 25.67 | 25.28 | 25.61 | 24.99 | 26.01 | 26.94 | 26.46 | 29.14 | 27.03 | 31.92 |
| Water | 5 | 20.19 | 24.40 | 20.85 | 25.02 | 23.92 | 25.24 | 25.01 | 25.52 | 26.40 | 26.15 | 29.52 | 26.87 | 33.09 |
| Avg | | | | 20.07 | | 23.39 | | 24.21 | | 25.91 | | 27.78 | | 29.87 |
| MC, % | | | | | | | | | | | | | | |
| STD | | | | 1.19 | | 1.58 | | 0.95 | | 1.09 | | 1.52 | | 2.47 |

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

1. A structural component, the structural component comprising:
a central body, the central body having an upper face and an opposed lower face and a central core located there between, wherein at least a portion of the central core is composed of a composite material, the composite material comprising:
a matrix material, the matrix material containing soil composition particles;
cellulose fibers; and
at least one organic compound, the at least one organic compound having at least one carboxylic acid having an aliphatic chain having between four and 28 carbon atoms.

2. structural component of claim 1 wherein the at least one carboxylic acid is the organic compound is unsaturated and has between two and five carbon-carbon double bonds.

3. The structural component of claim 2 wherein the at least one organic component includes a triglyceride selected from the group consisting of alpha linoleic acid, linoleic acid and mixtures thereof.

4. The structural component of claim 4 wherein the triglyceride further comprises at least one of the following: at least one saturated carboxylic acid having a C3 to C15 alkyl group, at least one monounsaturated carboxylic acid having a C3 to C15 alkyl group.

5. The structural component of claim 1 wherein the at least one organic compound is present in an amount up to 10% w/w.

6. The structural component of claim 1 wherein the organic compound is present in an amount between 0.5% and 7% w/w.

7. The structural component of claim 1 wherein the organic compound is an oil comprising oleic acid, linoleic acid and linolenic acid.

8. The structural component of claim 1 wherein the organic compound is an oil selected from the group consisting of linseed oil, walnut oil, poppyseed oil, tung oil and mixtures thereof.

9. The structural component of claim 1 wherein the cellulose fibers are derived from at least one of grasses, bamboo, flax, hemp, ramie, cocoa fiber, flax and wherein the cellulose fibers have been exposed to an alkaline environment for an interval between 2 and 20 hours, the cellulose fibers present in an amount between 0.5% and 10% w/w of the composite material.

10. The structural component of claim 7 wherein the cellulose fibers have an average diameter less than 5 mm and an average length less than 50 mm.

11. The structural component of claim 8 wherein the cellulose fibers are derived from bamboo having moisture content less than 40%.

12. The structural component of claim 9 wherein the bamboo is selected from the group consisting of Phyllostachys pubescens, Guadua angustifolia, Guadua anguisha and mixtures thereof.

13. The structural component of claim 7 wherein the cellulose fibers are present in the structural composite in an amount between 0 and 10% w/w.

14. The structural component of claim 1 wherein the soil composition particles comprise:
between 10 and 80% w/w clay, the clay including at least one of kaolinite, illite montmorillonite;
between 20 and 90% w/w of a non-clay component, the non-clay component containing at least one sand component and at least one fined soil component fined soil component, wherein the sand component contains at least one of calcium carbonate and/or silica and has an average particle size greater than 0.05 mm, and wherein fined soil component is derived from at least one of the following: topsoil, regolith, saprolite.

15. A structural component, comprising:
a central body, the central body having an upper face and an opposed lower face and a central core located there between, wherein at least a portion of the central core is composed of a composite, the composite comprising:
soil composition particles;
bamboo fibers present in an amount between 0 and 10% w/w, the cellulose fibers having an average diameter less than 5 mm and an average length less than 50 mm, wherein the bamboo fibers are derived from bamboo fibers that have been exposed to an alkaline environment for an interval between 2 and 20 hours; and
at least one organic compound present in an amount up between 0.5% and 10% w/w, the at least one organic compound including at least one carboxylic acid, wherein the at least one carboxylic acid is the organic compound is unsaturated and has between two and five carbon-carbon double bonds.
